(19) United States
(12) Patent Application Publication
(10) Pub. No.: US 2009/0172603 A1
(43) Pub. Date: Jul. 2, 2009

(54) METHOD AND APPARATUS FOR INFORMATION RETRIEVAL

(76) Inventor: Yisia Young Suk Lee, London (GB)

Correspondence Address: DICKSTEIN SHAPIRO LLP, 1825 EYE STREET NW, Washington, DC, 20006-5403, US

(21) Appl. No.: 11/719,936

(22) PCT Filed: Nov. 22, 2005
(86) PCT No.: PCT/GB05/04490

§ 371 Date: Jan. 22, 2009

(30) Foreign Application Priority Data
Nov. 22, 2004 (GB) 0425653.3

(51) Int. Cl. G06F 3/048

(52) U.S. Cl. 715/854

(57) ABSTRACT

Apparatus for displaying information from an information source, the information being indexed by nodes in a hierarchical structure, the apparatus comprising: at least one display for displaying information from the information source; a user input device for receiving a user-selectable forward navigation selection, a user-selectable back navigation selection and a user-selectable mode switch selection; and a controller for implementing a plurality of alternative navigation strategies to allow a user to navigate through at least part of the hierarchical structure using said forward navigation selection and said back navigation selection in order to display user-selected information from the information source on said at least one display, the controller being configured to switch from a currently selected navigation strategy to another of said alternative navigation strategies in response to reception of said user-selectable mode switch selection, wherein each navigation strategy comprises one or more rules defining an order in which the hierarchical structure is navigated.

The present invention relates to an apparatus and method for information retrieval and display, and in particular, to an apparatus and method for accepting user selection of information and outputting the selected information.

Information may often be conveniently indexed using a hierarchical directory structure. It is desirable to make it easy for a user to navigate through the hierarchical directory structure to locate information of interest to the user, and to provide an efficient menu based navigation system.

Alternatively, information may be indexed using an indexing system that defines a hierarchical structure for organising the information. For example, different parts of the information may be associated with different labels or definitions, defining the location in the hierarchical structure. The information may be divided into data files, and the given filenames, or information stored within the files, may define the location in the hierarchical structure. Alternatively, an index that is separate from the files, e.g. in the form of a list, may be provided, in order to define the hierarchical structure.

Hierarchically indexed information may be stored using a storage structure that is organised in a different way from the hierarchical structure defined by the indexing scheme. For example, information may be physically stored using a non-hierarchical storage arrangement, such as in the form of multiple data files within a single directory on a disk drive or other storage means. Alternatively, information may be stored in a hierarchical storage structure that is organised differently to the hierarchical information structure, such as within a system of directories on a disk drive or other storage means, and/or in a plurality of different network locations. It is desirable to make it easy for a user to navigate through a hierarchy of information organised in such a way. In currently known navigation systems such as web browsers, a “back” button may be provided to allow a user to retrace their path, and a “forward” navigation button may also be provided. However, the “forward” navigation button works only by returning to the original location after the user has made use of the “back” button. If the user has not made use of the “back” button, the “forward” navigation button is not activated, because there is no forward navigation strategy.

The present invention provides apparatus for displaying information from at least one information source. The information in the information source is indexed or arranged by an indexing scheme or an arrangement defining an information hierarchy. For example, the information may be arranged in a hierarchical directory structure, or the information may be labelled by a label or filename defining a location within the hierarchy. The information hierarchy may be described as a plurality of hierarchically arranged nodes, a plurality of said nodes each being associated with independently displayable information from the information source. Optionally, the information hierarchy may also include nodes that do not have associated independently displayable information. The apparatus includes at least one display for displaying information from the information source, a user input device for receiving a user-selectable forward navigation selection, a user-selectable back navigation selection and a user-selectable mode switch selection; and a controller. The controller is configured for implementing a plurality of alternative navigation strategies to allow a user to navigate through at least part of the information hierarchy using said forward navigation selection and said back navigation selection in order to display user-selected information from the information source on said at least one display. The controller is configured to switch from a currently selected navigation strategy to another of said alternative navigation strategies in response to reception of said user-selectable mode switch selection, wherein each navigation strategy comprises one or more rules defining an order in which the information hierarchy is navigated.

One embodiment comprises apparatus for displaying information from an information source, the information being indexed by nodes in a hierarchical structure, the apparatus comprising: at least one display for displaying information from the information source; a user input device for receiving a user-selectable forward navigation selection, a user-selectable back navigation selection and a user-selectable mode switch selection; and a controller for implementing a plurality of alternative navigation strategies to allow a user to navigate through at least part of the hierarchical structure using said forward navigation selection and said back navigation selection in order to display user-selected information from the information source on said at least one display, the controller being configured to switch from a currently selected navigation strategy to another of said alternative navigation strategies in response to reception of said user-selectable mode switch selection, wherein each navigation strategy comprises one or more rules defining an order in which the hierarchical structure is navigated.

The rules may be supplemented by or modified by further rules in particular embodiments of the invention. Each rule may be defined for the whole of the hierarchical structure or for only a part of the hierarchical structure, e.g. for the part of the hierarchy descending from a starting node at which navigation in a particular navigation mode begins. If the next node which would become a currently selected node is outside that part of the hierarchy, then that rule would not necessarily apply. In that case, different rules may apply to navigation in the rest of the hierarchical structure, or existing rules may be modified by further rules in the rest of the hierarchical structure. For example, the controller may be configured to display nodes in a different sequence depending on the starting point of navigation using a particular navigation strategy.

One advantage provided by embodiments of the present invention is to provide a predictive forward button having a forward navigation strategy, even in the absence of a prior path taken by the user.

The controller may be configured to display information from a history of previously displayed information in response to a back navigation selection. The back navigation selection may thus operate as an “undo” function, to revert back to earlier displayed information. Alternatively, the back navigation selection may allow the user to navigate through the same sequence of nodes as the forward navigation selection, only in a reverse order. The effect of the back navigation selection may be dependent on the selected navigation mode.

A navigation strategy need not completely define a sequence of nodes within the information source. For example, the navigation strategy may specify the relative order for displaying information corresponding to each of several levels of the hierarchy or for displaying information corresponding to each of several groups of nodes, but may not specify an order for displaying information corresponding to subnodes within such a level or group. Additional ordering information may be provided by a separate ordering rule which is not part of the navigation strategy. Together, the navigation strategy and the ordering rule may result in a complete order of display for all of the information in the hierarchy. Alternatively, if the navigation strategy involves cycling through only the sub-nodes of a parent node or cycling through only the nodes of a particular level of the hierarchy, the navigation strategy and the ordering rule may completely determine the order of display for this subset of the hierarchy.

Defining a navigation order may mean defining a complete navigation order for the whole of the hierarchical structure, or it may mean defining a partial navigation order, where the ordering relationship between some nodes or groups of nodes is known, but the ordering relationship between other nodes or groups of node is unknown.

It is preferable that the plurality of navigation strategies include a first navigation strategy which allows the user to move up and down through different levels of the hierarchy, e.g. a depth first search strategy, and a second navigation strategy which allows the user to move sideways within a particular level of the hierarchy, e.g. a breadth first search strategy.

A depth first strategy involves repeatedly navigating down to the next lowest level whilst there is information which is still to be displayed, followed by navigation within the same level whilst there is information which is still to be displayed, followed by moving back up the hierarchy to find the closest other branch of the hierarchy which has information still to be displayed, and repeating the process until no information remains to be displayed. Thus depth first navigation involves navigating towards the “leafs” of the tree structure where possible.

A selected node in the hierarchy which is positioned above a second node in the hierarchy may be known as an ancestor node of that second node, provided that the second node is in a branch of the hierarchy defined as the nested subnodes of the ancestor node, i.e. that the second node is a “descendent” of the ancestor node. A parent node is an example of an ancestor node.

A breadth first navigation strategy involves displaying all information on one level of the hierarchy before moving on to the next level of the hierarchy. A breadth first navigation strategy may be restricted to cycling through all the nodes within a single level or part of a level of the hierarchy, or may include a change of level after navigation through all or some of the nodes on the currently selected level of the hierarchy.

The choice of navigation strategy may be switched during any part of the navigation. Thus the starting node for any particular navigation strategy may be any node in the hierarchy. In the depth first navigation strategy, one embodiment involves the information corresponding to each nested sub-node of the starting node being displayed in turn first, and then further navigation comprising the same node sequence as the node sequence that would occur if navigation had started at the highest level node (the “root” node). In other words, after navigation has proceeded through all subnodes of the starting node, navigation then proceeds to sub-nodes of ancestor nodes of the starting node, if these subnodes have not yet been displayed since the controller switched into the current navigation mode.

An alternative is that other nodes in the same level of the hierarchy as the starting node are displayed regardless of whether they occur before or after the starting node using the ordering rule, provided that they have not already been displayed since the controller switched into the current navigation mode.

The apparatus may be configured to generate an ordered list of nodes starting at the root node each time a new mode selection is made, or a different ordering rule is chosen. The list may then be used to control the order of navigation, by starting within the list at the currently selected node. However, it is not essential that such a list is generated or stored in memory. An alternative is for the controller to simply use a set of rules corresponding to the navigation strategy and ordering rule each time a new user navigation selection is received by the controller.

The ordering rule may be user-specified, may specify a fixed criteria or may be controlled by further criteria determined by the computer apparatus, e.g. it may be pre-set according to the user identity.

Any type of ordering rule is possible. For example, the ordering rule may be alphabetical ordering by a node name or by a subject header which forms part of the information to be displayed, ordering by the amount of information at a particular node of the hierarchy e.g. by file size, number of files, or by the quantity of text, images, and/or sounds, etc. The ordering rule may be ordering according to the number of immediate subnodes of each node, the number of nested subnodes, the total amount of information corresponding to these subnodes, the maximum depth of nested subnodes in the hierarchical structure, the time the information was last viewed (either by a particular user or by any user), the time the information was added to the hierarchical information source, the type of information, the file type, the hit count for previous viewing of that information, the frequency of previous viewing of that information over a predetermined time period, etc. Many other types of ordering are also possible. It is not essential that the ordering is determined by a logical rule. The ordering may even be arbitrary or random, or determined by technical considerations such as storage location on a hard disc or other storage device.

Reverse ordering may be used corresponding to any of the above ordering rules, for example, reverse alphabetical ordering may be used. Combinations of ordering methods may be used. It is possible for different levels of the hierarchy to be ordered in different ways, and/or for the subnodes of different nodes to be ordered in different ways by different rules.

Thus the present invention provides a user interface which allows for easy navigation of a hierarchically organised information structure.

The apparatus according to embodiments of the invention may comprise any computing device, including handheld or portable computing devices. For example, the apparatus may comprise a PC (personal computer), a set top box with a TV, a PDA (personal digital assistant), an electronic book reader, a mobile phone, a digital audio player, a GPS (global positioning satellite) receiver, etc. The invention is ideal for use with a device of limited size. Where embodiments of the present invention are used with a computer having a small screen, this has the advantage of allowing very efficient use of the limited display area available on the screen, by dedicating all or most of the screen to information display, and minimal area of either the screen or the apparatus itself is taken up by a user input device. For example, three physical buttons or touch-screen buttons may be all that is required.

The display may be a monitor, TV screen, touch screen, or any other type of screen or display for use with a computing device. The display may be configured to display a navigation panel in an area of the display, the navigation panel comprising a complete or partial mapping of the node structure for allowing alternative navigation with a further user input device.

The user input device may be a keyboard, keypad, mouse, pen, game controller, joystick, remote control, track pad, tracker ball or other pointer device, touch sensitive screen or any other device for allowing a user to input information to the apparatus.

The user input device may be a keypad with three keys, or a keypad with two keys, where mode selection is operated by pressing both keys simultaneously, or a joystick e.g. a mini-joystick which is operated by the fingers rather than a handheld joystick. It may be a pressure controlled device such as a trackpoint device or touch pad. It may be a keyboard, where only a small number of the keys are used for the navigation user input. A combination of input devices may be used.

The controller may be a computer, embedded computing device, PDA, mobile phone, etc. The information store may be a disc such as a hard disk, floppy disc, CD, DVD, optical disc, etc, and the information store may be provided as part of the computing device, or it may be remote from the computing device. The information store may be of a read-only type or may be of a read-write type.

The information in the information source may include text, web pages, photographs, images or video images for displaying on a screen, and/or audio information, such as digital speech or music, for outputting through a speaker. The information may be stored as an information hierarchy, or the information may be indexed by a hierarchical node structure. At least some of the information may be generated dynamically when a user input is received to navigate to that information. Such dynamically generated information may be accessed from one or more physical location.

The information may all be stored in a single physical location, such as a disc drive, or may be distributed amongst a plurality of physical locations, which may be connectable via one or more networks. The information may be stored within a directory structure which at least partially corresponds to the structure of the information hierarchy, e.g. information at the top level of the hierarchy may be stored in top level directories, and information at lower levels of the hierarchy may be stored in subdirectories. Alternatively, the information may be stored within a file structure that does not correspond to the structure of the information hierarchy. One example is where the information in the information source is all stored within a single directory, and the hierarchical information structure is defined by indexing means such as by filenames or labels associated with each file in the information source, or by using an index or list containing information on the hierarchical structure.

For example, a first part of the filename or label may define a position in the hierarchy, a second part of the filename or label may define a branch of the hierarchy below the first defined position, and subsequent parts of the filename or label may define sub-branches of the hierarchy. Thus, the filename or label may specify the route from the top of the hierarchy to the location of the named or labelled information within the hierarchy. An information source may be constructed of a plurality of the files stored within a single directory on a computer storage device, or stored in distributed physical locations or virtual locations, and the hierarchical structure be defined by associated filenames or labels. Part of the filename or label may relate to the position of the file in the hierarchy, or the entire filename or label may determine this.

The labelling to define a hierarchy can easily be processed by computer programming languages, e.g. XML (Extensible markup language), PHP (PHP Hypertext Pre-processor) and SQL (Structured Query Language), which may thus be used to identify the next item of information to be retrieved using a selected navigation strategy.

The apparatus of the invention may include a touch sensitive screen, which may be selected using a variety of methods, such as by a person's finger or using a stylus. The apparatus may include a loudspeaker, for playback of audio information. However, the present invention is not limited to such a technology or design.

The information source(s) may be provided on a computer, together with code for configuring the computer as an apparatus according to the present invention, or the information source(s) may be separate or remote from the apparatus, whereby the information is accessed by the apparatus e.g. over a communications link. Alternatively the information may be provided separately or remotely from the apparatus and the apparatus accesses the information e.g. over a network.

The information source(s) may include information which is arranged in a hierarchical structure corresponding to a network of hierarchically interlinked nodes. The individual items of information making up the information source are each associated with a node. The structure may have a single top level mode or “root” mode, which is interlinked to each node lower in the hierarchy. The top level node may be interlinked to each node lower in the hierarchy via a unique path, or via a choice of alternative paths. Each node may be associated with a node reference which is used to identify the node, such as a node name, label or ID number.

The present invention can be implemented by software or programmable computing apparatus. This includes any computer, including PDAs (personal digital assistants), mobile phones, etc. Thus the present invention encompasses a carrier medium carrying computer readable code for configuring a computer or number of computers as the apparatus of the invention. The carrier medium can comprise a transient medium, e.g. an electrical, optical, microwave, RF, electromagnetic, acoustic or magnetic signal (e.g. a TCP IP signal over an IP network such as the internet), or a carrier medium such as a floppy disk, CD ROM, hard disk, or programmable memory device.

In embodiments of the present invention, selection of the forward and back user selections may result in an automatic updating of information on the display.

The use of a single control button to cycle through all possible navigation modes provides the advantage of saving space on a device of limited size, for example, a PDA (personal digital assistant). If the buttons are displayed on the screen, then the amount of screen area required to display the buttons is minimised. If the buttons are only present as hardware input controls, then by minimising the overall number of buttons, the overall size of the hardware may be minimised.

Thus, embodiments of the invention allow the size of hardware to be minimised whilst available display area for the information is maximised, due to the need for only three different user input selections. This is particularly useful on mobile devices or other size limited devices.

Embodiments of the invention provide the advantages of predictive forward navigation, which is not seen in prior art user interfaces such as web browsers, and provides the advantage of allowing a user to easily navigate through the information.

A further advantageous feature of some embodiments is the automatic display of new information to response to a forward or back user selection being received by the controller. This avoids the need for an additional key such as an “enter” key to be pressed to confirm the selection.

It may be the case that where particular node has a large number of subnodes, then it takes a long time to scroll through these subnodes using the forward and back navigation controls. However, the apparatus may be configured to allow a shortcut navigation step to a different part of the hierarchical structure using alternative navigation controls or other user input controls.

In some embodiments, the use of an additional method of navigation with a further user input device or an additional part of a current user input device (such as additional keys on a keyboard) allows shortcuts to be taken from one part of the node structure to another. A menu may be displayed on the display to allow a user to select such navigation shortcuts. Menu items may be selected, for example, using a pointer displayed on the display, for example, a pointer linked to a mouse or other input device. Alternatively, menu items may be selected without a pointer being displayed on the screen, e.g. by use of a touch sensitive screen, where a user touches a part of the screen corresponding to the menu item. Menus and items may be selected by the positioning of the pointer on the screen, and/or by a user clicking or activating a pointer device, or by single or multiple touches to a touch sensitive screen.

Embodiments including further user input devices may be implemented using any computing device. Such embodiments are particularly suited to a computer which is already provided with a user input device capable of accepting further user inputs such as a full keyboard, or a computer which is already provided with a plurality of user input devices such as a mouse and keyboard. Embodiments of the invention allow a common core user interface to be used with different types of computer apparatus, and additional user-interface features to be included in specific embodiments, where the additional user-interface features are specific to or selected for particular types of computer apparatus.

Additional visual information may be used to assist a user with navigation, for example, the colour of a part of the display may be changed according to which level of the hierarchy and/or which particular branch of the hierarchy is being displayed, or when the navigation proceeds to a different group of subnodes.

Embodiments of the present invention will now be described, by way of example only, with reference to the accompanying drawings, in which:

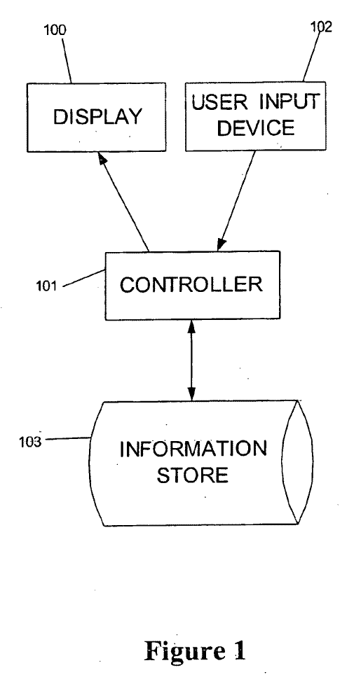

FIG. 1 is a block diagram showing the apparatus according to an embodiment of the invention;

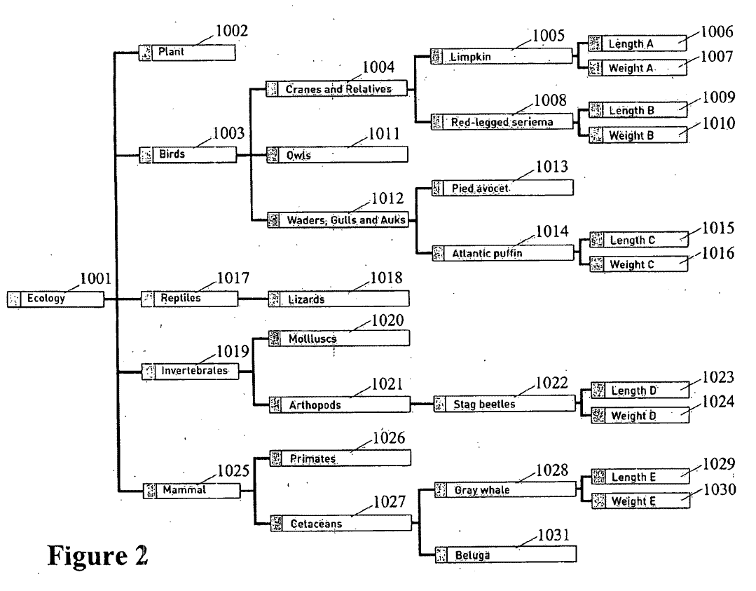

FIG. 2 is a tree diagram showing an example of a hierarchical information structure used in an embodiment of the invention;

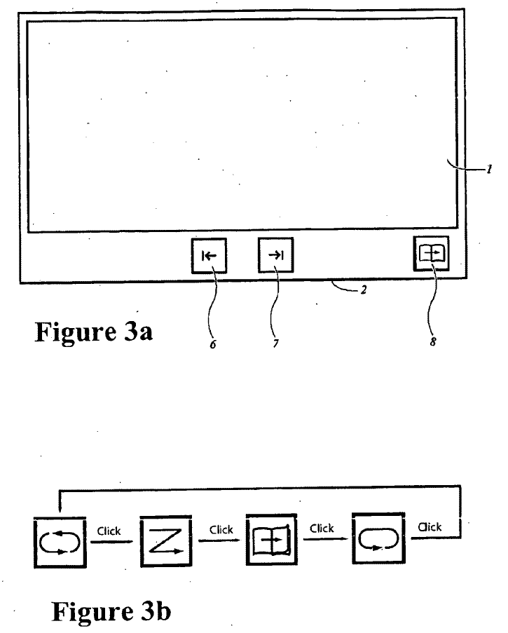

FIG. 3a is a screen layout showing the layout of a screen on a computer display in an embodiment of the invention. FIG. 3b shows the navigation mode icons used in the screen layout of FIG. 3a;

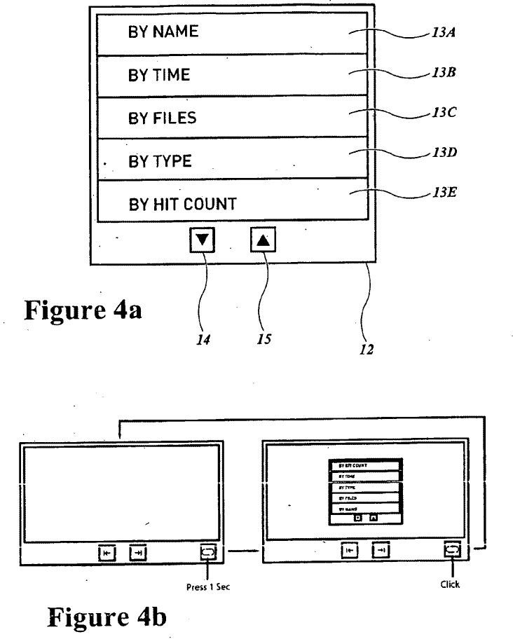

FIG. 4a is a partial screenshot of a menu arrangement for user-selection of the order in which information is displayed. FIG. 4b shows two screenshots demonstrating the menu of FIG. 4a being invoked by a user.

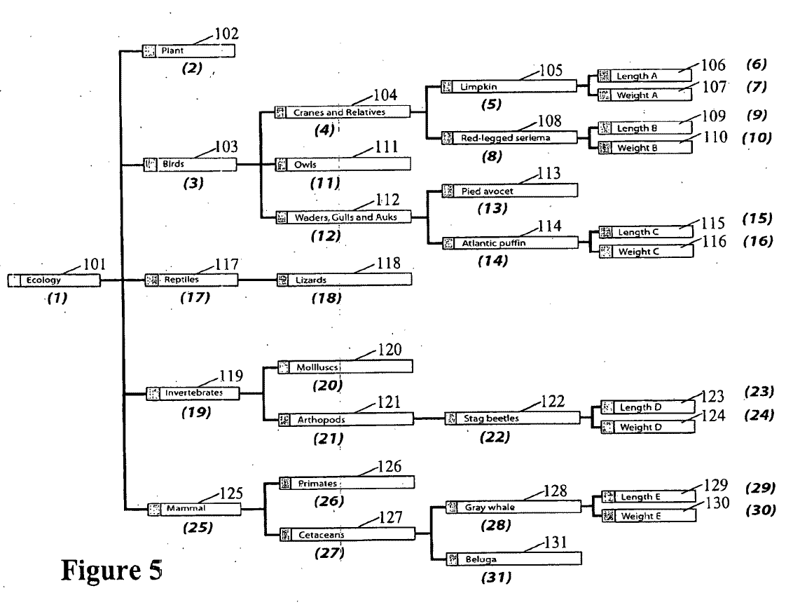

FIG. 5 shows the tree diagram of FIG. 2, with additional labels to indicate the order of information display in a “book order” navigation mode, in an embodiment of the invention;

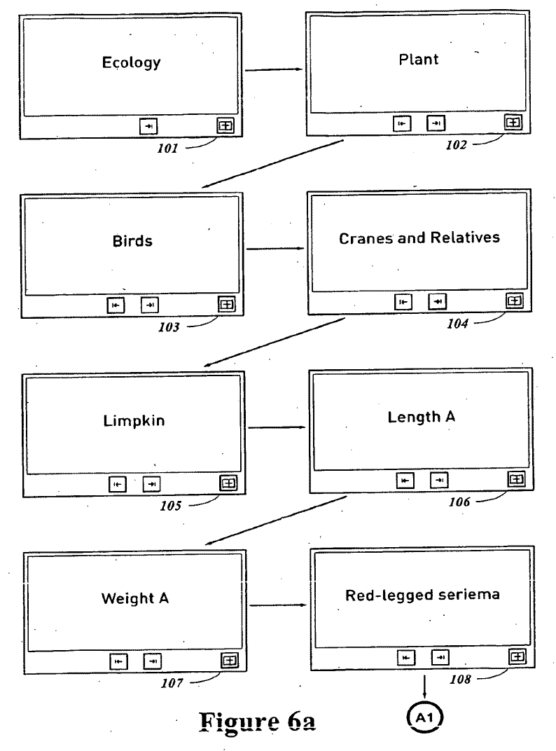

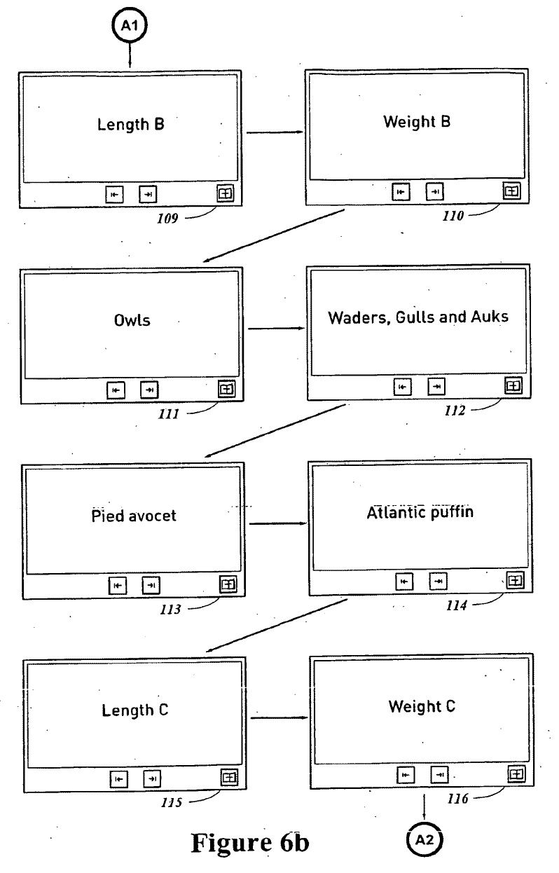

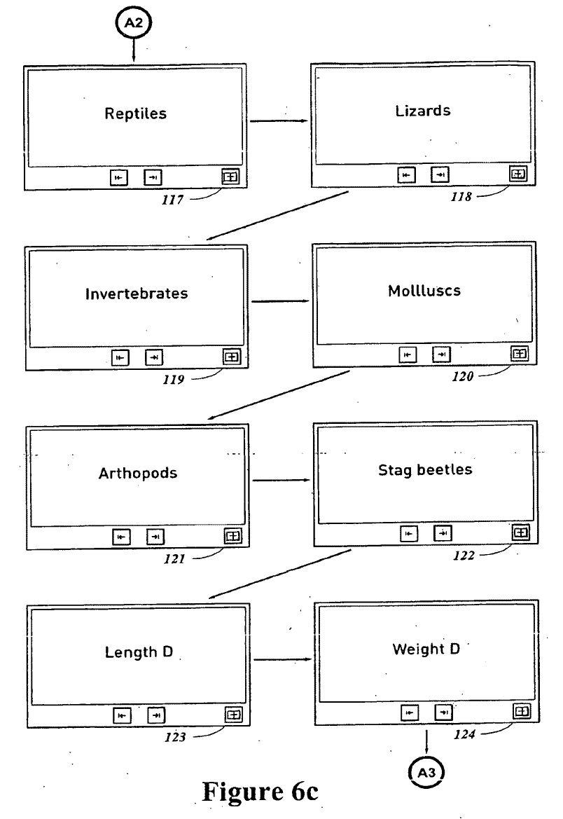

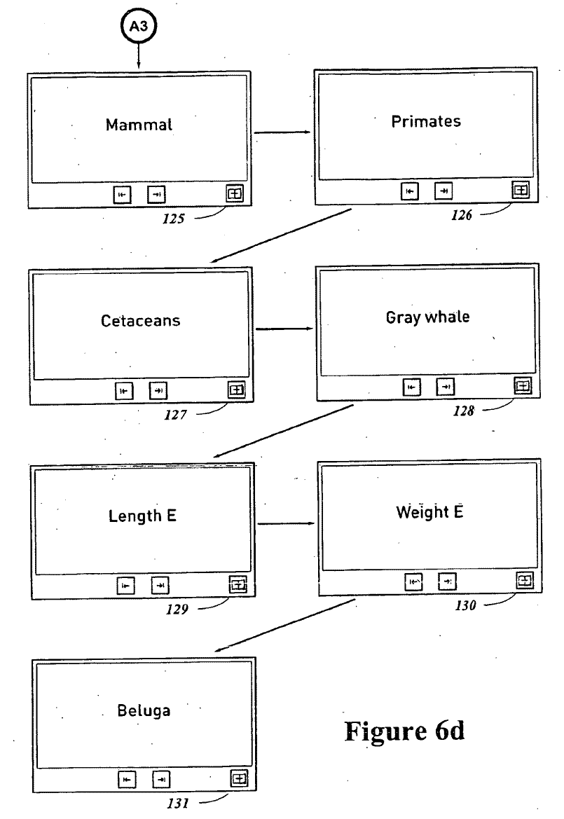

FIGS. 6a to 6d show a plurality of individual screenshots, and the way in which these screenshots inter-relate to one another as navigation proceeds from the top level of the hierarchical structure of FIG. 5 to the bottom level of the hierarchical structure of FIG. 5, in a “book order” navigation mode.

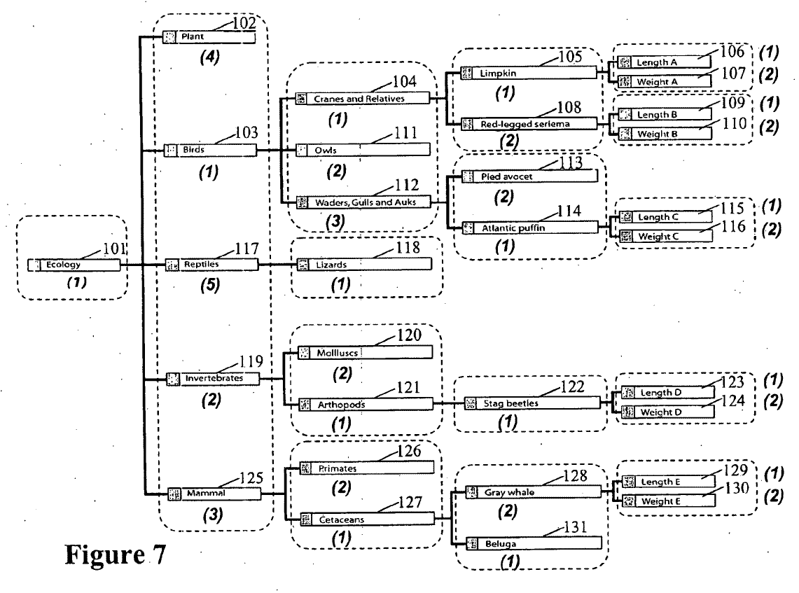

FIG. 7 shows the tree diagram of FIG. 2, with additional labels to indicate the order of information display in a “group cycle” navigation mode, using alphabetical ordering;

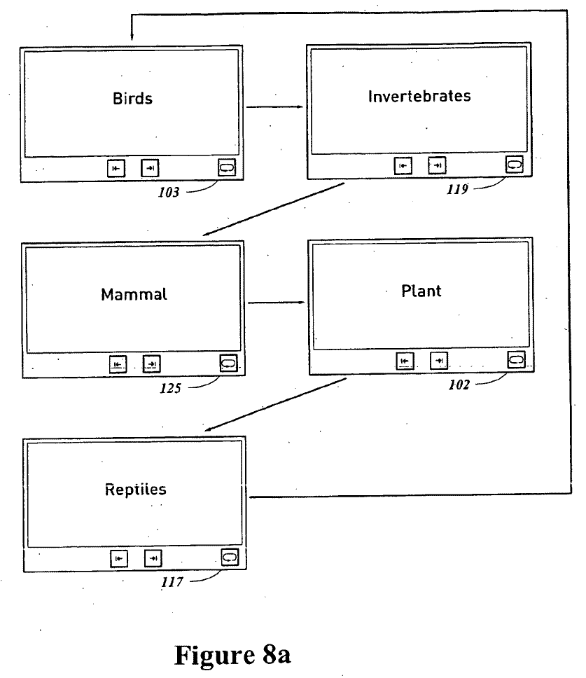

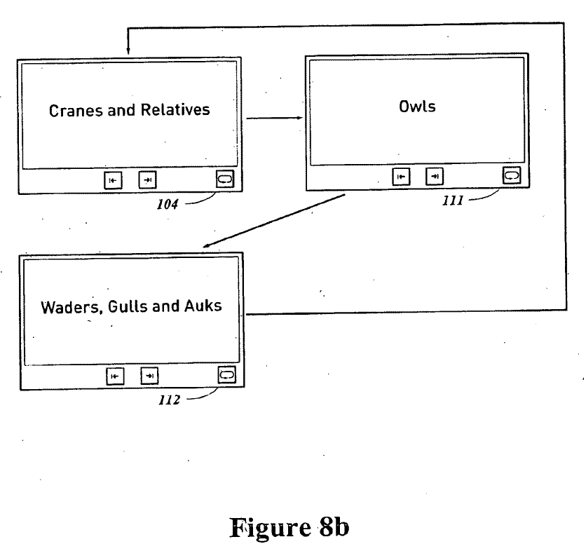

FIGS. 8a and 8b shows a plurality of individual screenshots, and the way in which these screenshots inter-relate to one another as navigation proceeds within the “group cycle” navigation mode illustrated in FIG. 7.

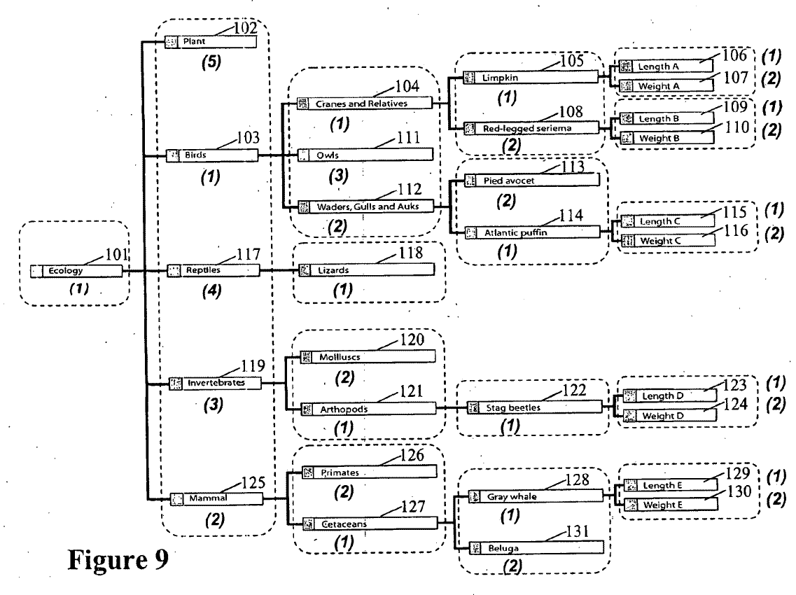

FIG. 9 shows the tree diagram of FIG. 2, with additional labels to indicate the order of information display in a “group cycle” navigation mode, using ordering based on size, then alphabetical ordering;

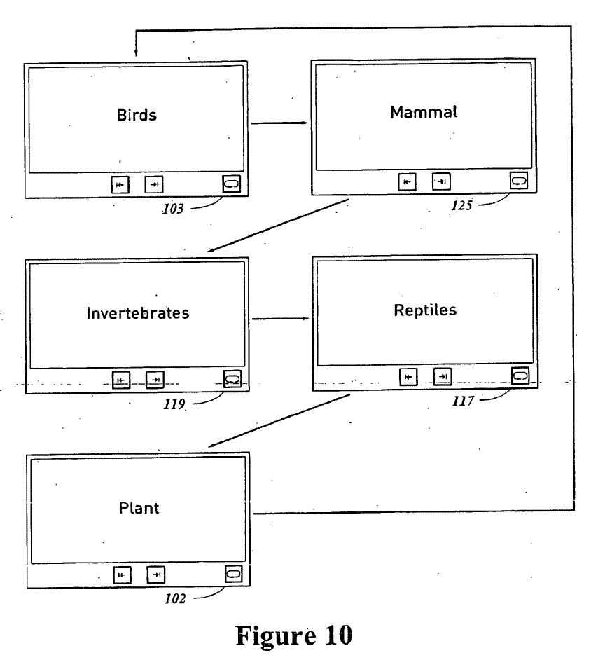

FIG. 10 shows a plurality of individual screenshots, and the way in which these screenshots inter-relate to one another as navigation proceeds within the “group cycle” navigation mode illustrated in FIG. 9.

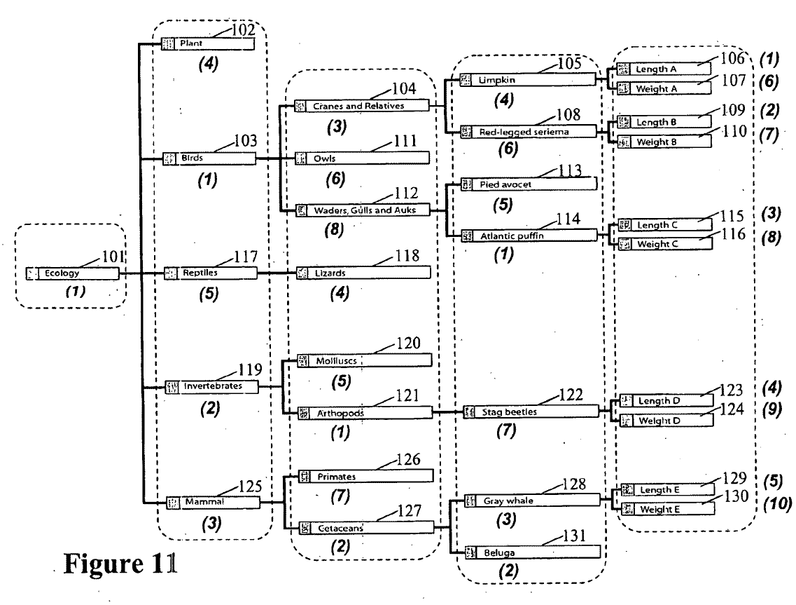

FIG. 11 shows the tree diagram of FIG. 2, with additional labels to indicate the order of information display in a “level cycle” navigation mode, using alphabetical ordering;

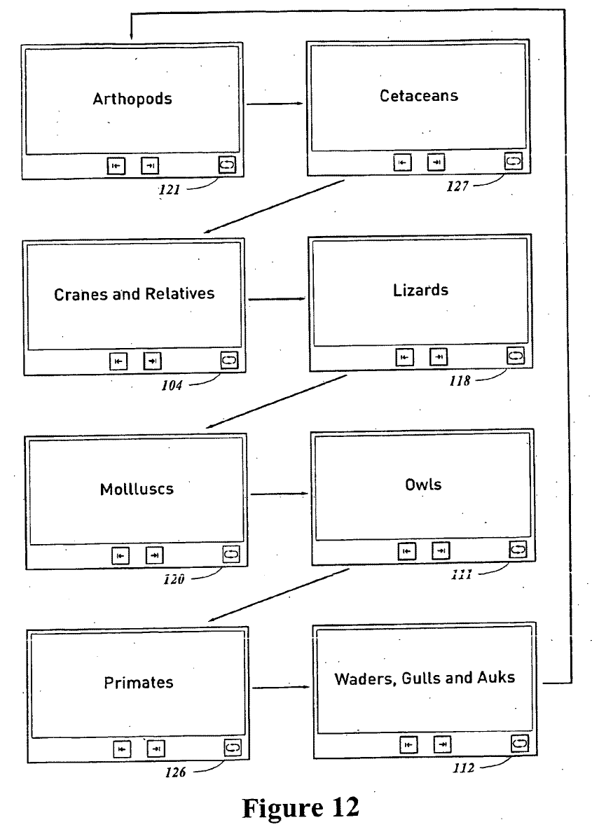

FIG. 12 shows a plurality of individual screenshots, and the way in which these screenshots inter-relate to one another as navigation proceeds within the “level cycle” navigation mode illustrated in FIG. 11;

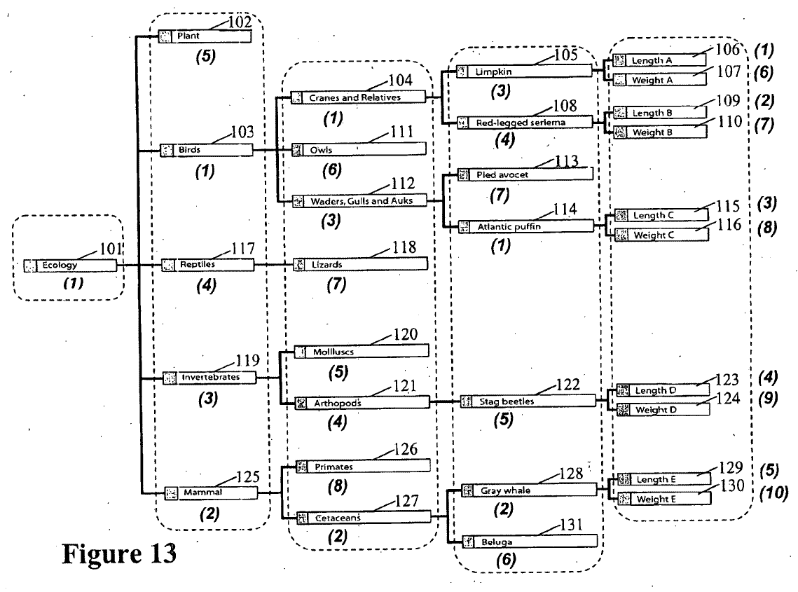

FIG. 13 shows the tree diagram of FIG. 2, with additional labels to indicate the order of information display in a “level cycle” navigation mode, using ordering based on size, then alphabetical ordering;

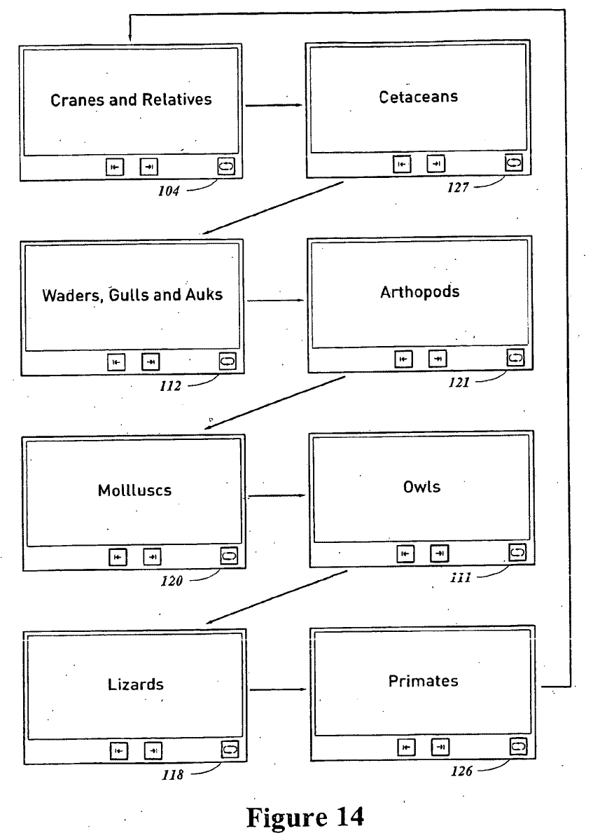

FIG. 14 shows a plurality of individual screenshots, and the way in which these screenshots inter-relate to one another as navigation proceeds within the “level cycle” navigation mode illustrated in FIG. 13;

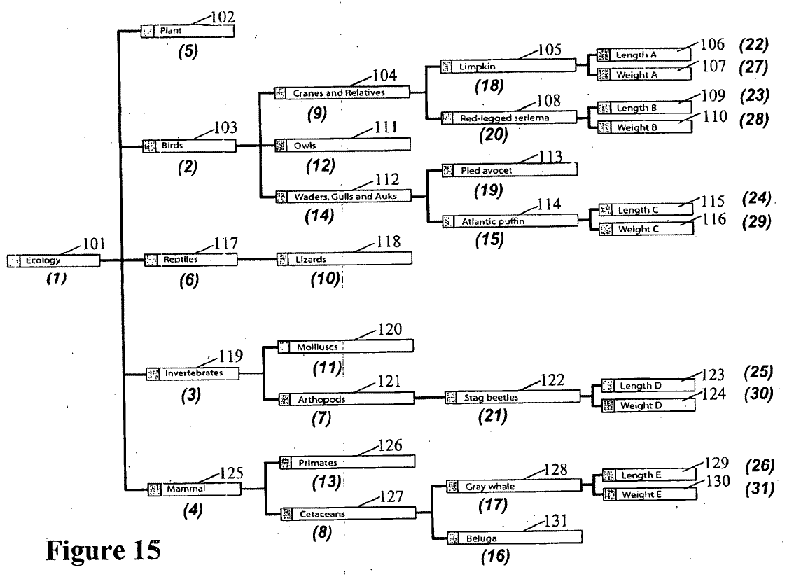

FIG. 15 shows the tree diagram of FIG. 2, with additional labels to indicate the order of information display in a “zigzag” navigation mode, using alphabetical ordering;

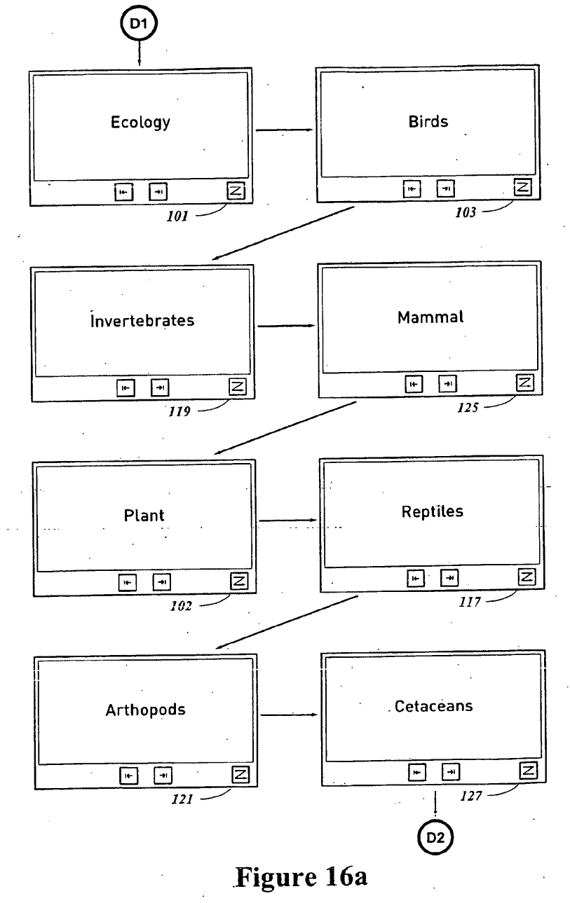

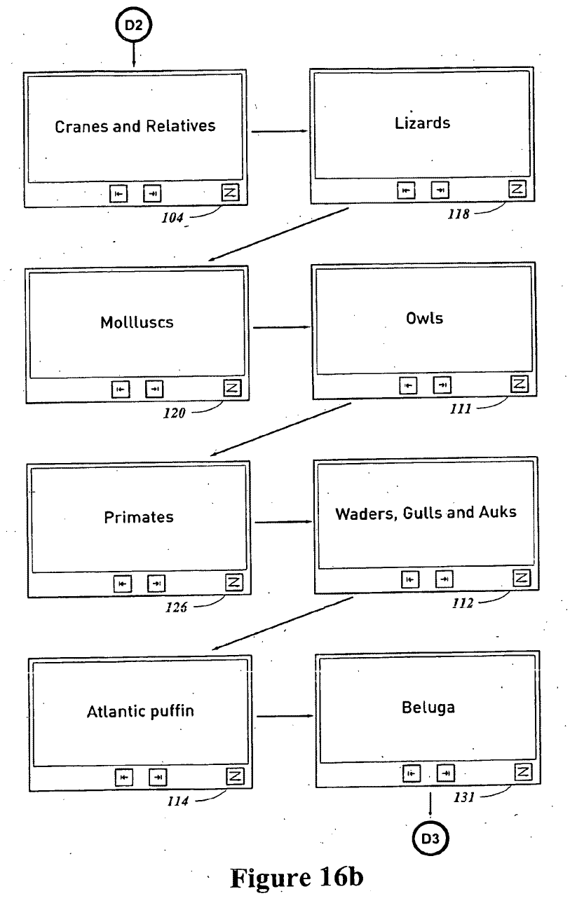

FIGS. 16a and 16b show a plurality of individual screenshots, and the way in which these screenshots inter-relate to one another as navigation proceeds within the “zigzag” navigation mode illustrated in FIG. 15;

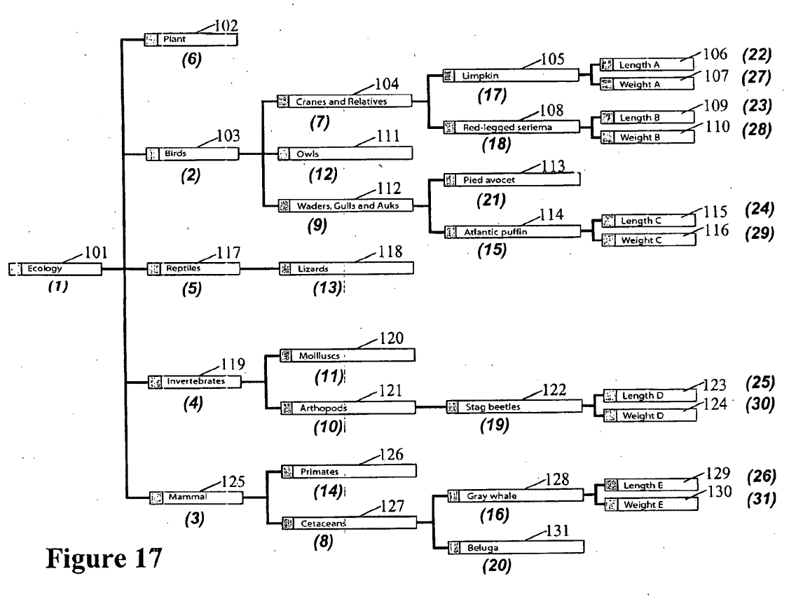

FIG. 17 shows the tree diagram of FIG. 2, with additional labels to indicate the order of information display in a “zigzag” navigation mode, using ordering based on size, then alphabetical ordering;

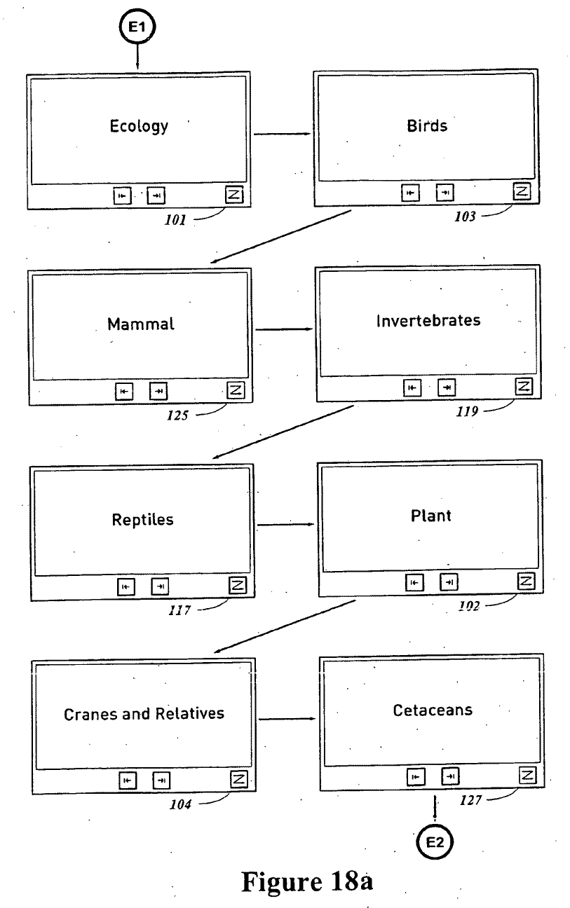

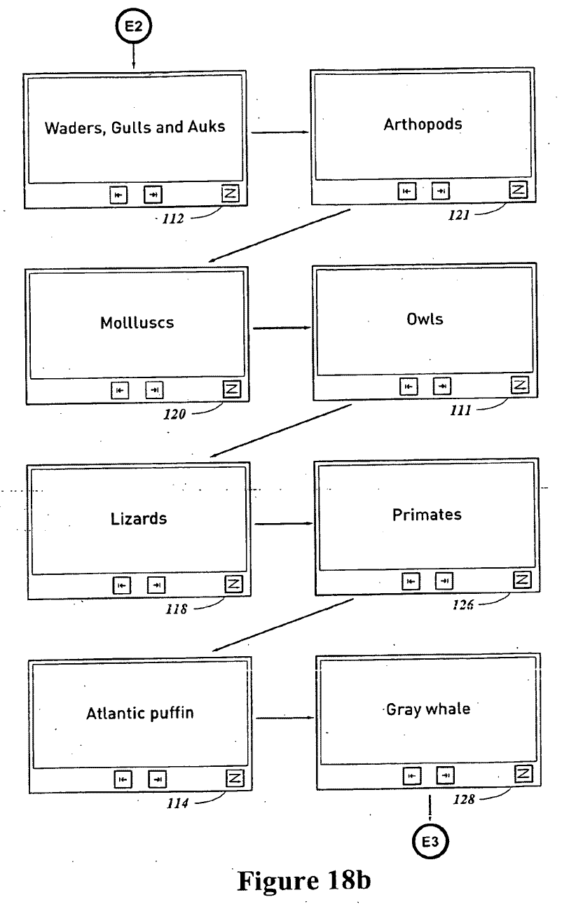

FIGS. 18a and 18b show a plurality of individual screenshots, and the way in which these screenshots inter-relate to one another as navigation proceeds within the “zigzag” navigation mode illustrated in FIG. 17.

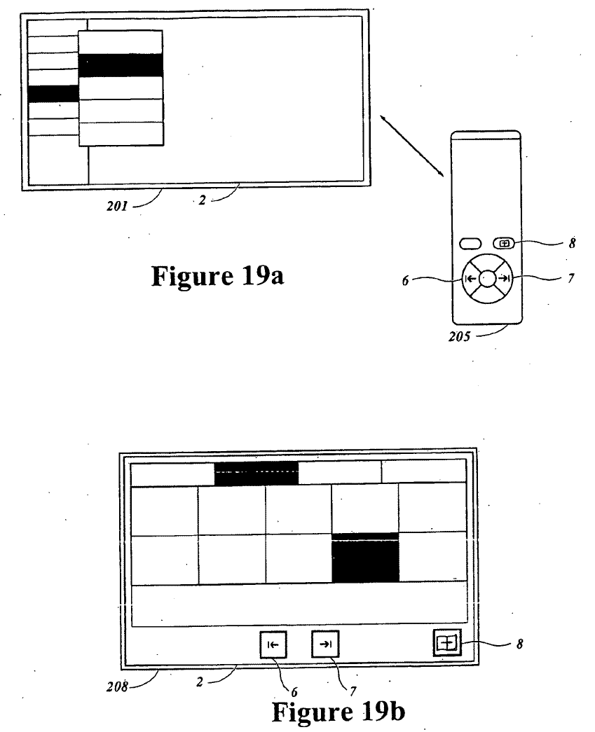

FIG. 19a shows a screen layout used to display menus in a further embodiment of the invention, and a remote control unit used to select items from the menus. FIG. 19b shows an alternative screen layout used to display menus.

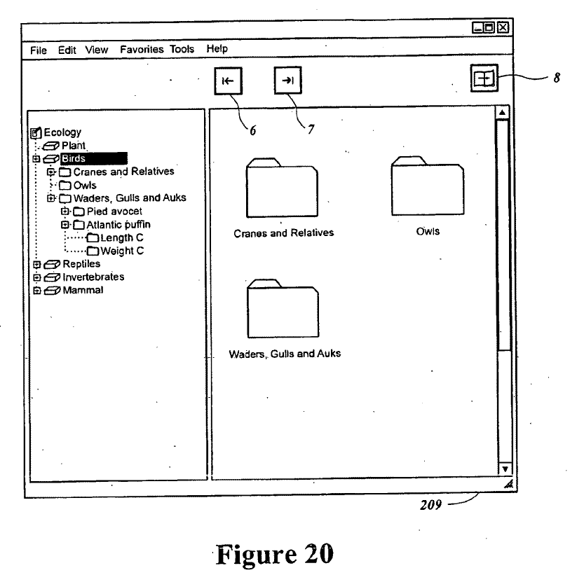

FIG. 20 shows a screen layout allowing navigation by both the user navigation buttons according to an embodiment of the invention, and an alternative pointer-type user input.

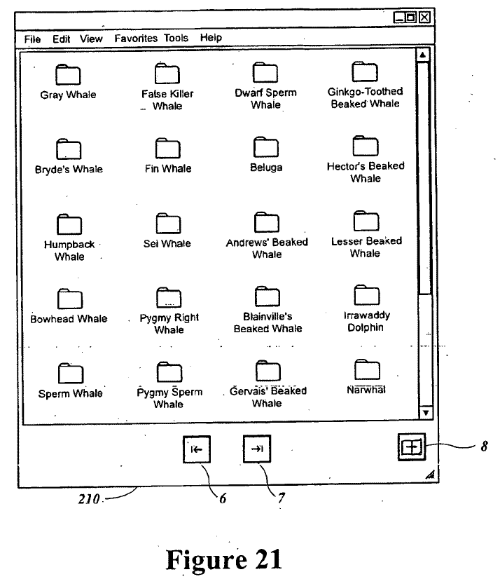

FIG. 21 shows an alternative screen layout allowing navigation by both the user navigation buttons according to an embodiment of the invention, and an alternative pointer-type user input.

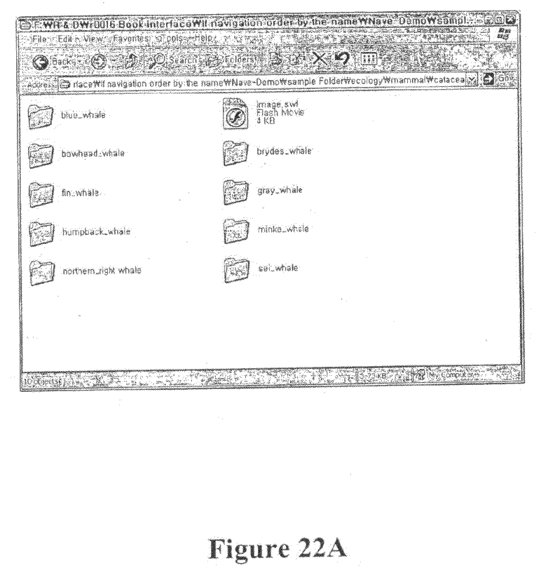

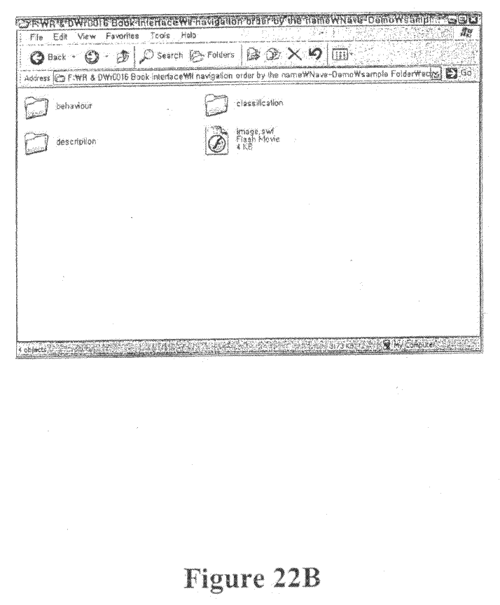

FIGS. 22a and 22b are computer screenshots displaying part of a directory structure which corresponds to the hierarchical information structure in one embodiment of the invention;

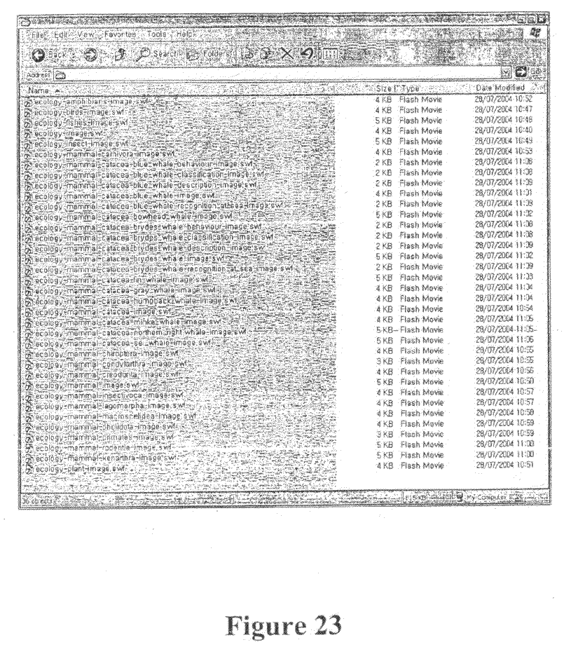

FIG. 23 is a computer screenshot displaying the contents of a single directory in a computer file system, comprising files corresponding to a plurality of levels of the hierarchy, in another embodiment of the invention;

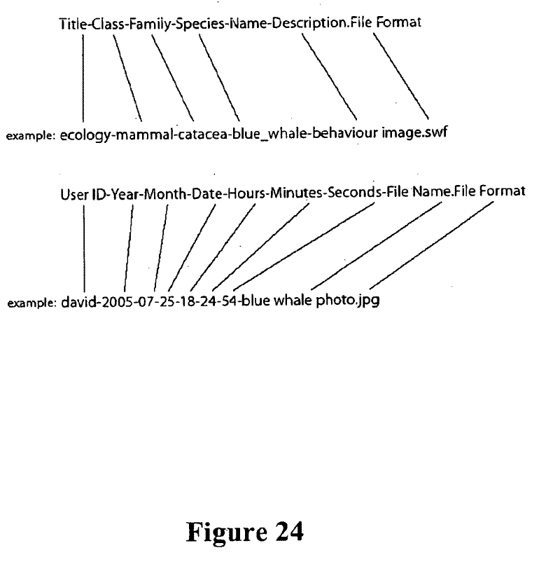

FIG. 24 shows examples of how a filename can be used to define the location of a file within an information hierarchy;

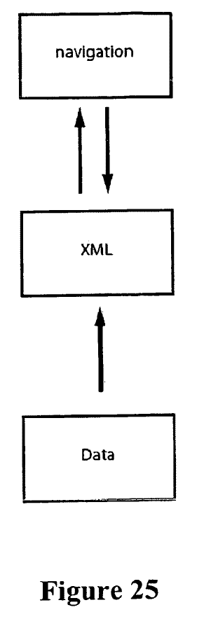

FIG. 25 is a schematic diagram indicating the data flow between a navigation interface, an XML processor and data from an information source, in an embodiment of the invention;

An apparatus according to a first embodiment of the invention is shown in FIG. 1. The apparatus includes a controller 101 connected to a display 100 and a user input device 102. The controller is also connected to an information store 103. The controller 101 is configured to receive user input from the user input device 102, select and retrieve information from the information store 103, and output the retrieved information to the display 100. The user input device 102 may be integral with the display 100, or may be separate. The user input device could be integral by being a touch sensitive mechanism provided on the display.

The apparatus may comprise a program memory, where the controller 101 loads and implements program code stored in the program memory to control the display 100 and the user input device 102 to access the information store 103.

FIG. 2 shows an example of a hierarchical information structure for use with embodiments of the present invention. A tree-like network of lines is shown, to indicate the relationships between nodes in the hierarchy. The top level node 1001 is entitled “Ecology”. It has five subnodes, which are “Plant” 1002, “Birds” 1003, “Reptiles” 1017, “Invertebrates” 1019 and “Mammal” 1025.

The “Plant” 1002 node in this example has no subnodes of its own.

The “Birds” 1003 node has three sub-nodes. The subnodes are “Cranes and relatives” 1004, “Owls” 1011 and “Waders, Gulls and Auks” 1012. The “Cranes and relatives” 1004 subnode has two further subnodes for “Limpkin” 1005 and “Red-legged seriema 1008. Each of these two further subnodes has a subnode for length 1006, 1009 and a subnode for weight 1007, 1009. The “Owls” 1011 subnode has no further subnodes. The “Waders, Gulls and Auks” 1012 subnode has two further subnodes, which are “Pied avocet” 1013 and “Atlantic Puffin” 1014. The “Pied avocet” 1013 subnode has no further subnodes, but the “Atlantic Puffin” node has subnodes for length 1015 and weight 1016.

The “Reptiles” 1017 node has one sub-node, which is “Lizards” 1018. The “Lizards” 1018 subnode has no further subnodes.

The “Invertebrates” 1019 node has two sub-nodes. The subnodes are “Molluscs” 1020 and “Arthropods” 1021. The “Molluscs” 1020 subnode has no further subnodes. The “Arthropods” 1021 subnode has one further subnodes, which is “Stag Beetles” 1022. The “Stag Beetles” 1022 subnode has subnodes for length 1023 and weight 1024.

The “Mammal” 1025 node has two sub-nodes. The subnodes are “Primates” 1026 and “Cetaceans” 1027. The “Mammal” 1025 subnode has no further subnodes. The “Cetaceans” 1027 subnode has two further subnodes, which are “Gray Whale” 1028 and “Beluga” 1031. The “Gray Whale” 1028 subnode has no further subnodes, but the “Beluga” subnode has subnodes for length 1029 and weight 1030.

In addition to many of the nodes in FIG. 2 having subnodes, each node of the hierarchy may correspond to information specific to that node, regardless of its position in the hierarchy.

FIG. 3a shows a screen layout for a computer screen in an embodiment of the invention. The screen 2 has a display area 1, and three control button areas 3, 4, 5 displayed in the lower part of the screen. The control buttons relate to back navigation, forward navigation, and mode selection respectively. The first two control button areas 3, 4 show left and right arrows to indicate a “back” 6 and a “forward” 7 control respectively. The third control button area 5 shows a navigation mode symbol 8 to pictorially indicate the current navigation mode. In this example, the symbol 8 is a book, indicating that the current navigation mode is “book mode”.

If the screen is a touch sensitive screen, these control button areas of the screen may be configured as touch sensitive buttons. If the screen is not a touch sensitive screen, they may be operable using a user input device such as a pointer device, by moving a cursor on the screen onto the position of the buttons. Alternatively, they may be used to. visually indicate when a key or button on a keypad or keyboard is activated.

FIG. 3b shows the four possible mode icons used in this particular embodiment of the invention, and illustrates the transition between the different modes when the mode switch user selection is operated. The four icons represent “level cycle” mode, “zigzag” mode, “book” mode and “group cycle” mode. Each of these modes will later be described in more detail. When the mode switch user selection is received from the user input device 102 by the controller 101, the mode changes to the next mode in the sequence. At the end of the sequence of four modes, a further mode switch user selection will result in a switch back to the first mode.

Embodiments of the invention are not limited to these four navigation modes, and other modes are also possible.

FIG. 4a shows a menu which may be used in some embodiments of the invention to allow a user to select an order of information display. The order is used by the controller together with the rules for the selected mode, to determine a sequence for displaying information on the display 100.

The menu 12 of FIG. 4a includes the options of ordering nodes by name 13A, by time 13B, by files 13C, by type 13D or by hit count 13E. The menu 12 has a button with a down arrow 14 and a button with an up arrow 15. If further ordering options are available, and if there is not room to display these on the menu 12, then the up and down arrows 14, 15 may be used to scroll through the ordering options.

FIG. 4b shows two screenshots demonstrating the menu of FIG. 4a being invoked by a user. In this embodiment, the mode button may be pressed for a longer than normal period, such as 1 second, as shown in the first screenshot of FIG. 4b. This results in the menu 12 being displayed in the central area of the screen, as shown in the second screenshot of FIG. 4b. When an appropriate selection has been made, the menu may be hidden by clicking on the mode button.

FIG. 5 shows the tree diagram of FIG. 2, with additional labels to indicate the order of information display in a first navigation mode. This first navigation mode is “book mode”. In “book mode”, the navigation sequence starts at a top level node, proceeds to a first subnode of the top level node, then to a first subnode of the first subnode, etc. When the bottom of the hierarchy is reached, navigation resumes from the second subnode of the next lowest level, and this pattern is followed throughout the complete list of nodes and subnodes.

In the example given in FIG. 5, the starting point for the “book mode” information sequence is the top level node “Ecology” 101, which is labelled with (1) on FIG. 5 to indicate its position in the sequence.

In this example, the next node in the sequence is “Plant” 102 and is labelled (2) to indicate its second position. “Plant” 102 is chosen because the ordering of the “chapters” of the book, i.e. the subnodes of the root node, is Plant, Birds, Reptiles, Invertebrates, Mammal. In an embodiment where the chapters were ordered differently, e.g. in alphabetical order, then “Plant” may not be the second node of the “book order” sequence.

The third node of the sequence is “Birds” 103 and is labelled (3), because “Plant” 102 does not have any subnodes. The fourth node is “Cranes and Relatives” 104 and is labelled (4). “Cranes and Relatives” is chosen in preference to the other subnodes of “Birds” because the “sub-chapter” order in this example is “Cranes and Relatives”, “Owls”, “Waders, Gulls and Auks”.

The fifth node of the sequence, labelled (5), is “Limpkin” 105, which is the first subnode of “Cranes and Relatives” 104. The sixth node, labelled (6), is “Length A” 106, and this is the first subnode of “Limpkin” 105. At this stage, there are no further subnodes below “Length A” 106, so the sequence moves on to the second subnode of “Limpkin” 105, which is “Weight A” 107.

There are now no further subnodes of either “Weight A” 107, or of “Limpkin” 105, so the next node in the sequence, labelled (8), is “Red Legged seriema” 108, which is the second subnode of “Cranes and Relatives” 104.

A similar pattern follows for the rest of the sequence. In summary, the remaining order is “Length B” 109 which is labelled (9), “Weight B” 110 which is labelled (10), “Owls” 111 which is labelled (11), “Waders, Gulls and Auks” 112 which is labelled (12), “Pied avocet” 113 which is labelled (13), “Atlantic Puffin” 114 which is labelled (14), “Length C” 115 which is labelled (15), “Weight C” 116 which is labelled (16), “Reptiles” 117 which is labelled (17), “Lizards” 118 which is labelled (18), “Invertebrates” 119 which is labelled (19), “Molluscs” 120 which is labelled (20), “Arthropods” 121 which is labelled (21), “Stag Beetles” 122 which is labelled (22), “Length D” 123 which is labelled (23), “Weight D” 124 which is labelled (24), “Mammal” 125 which is labelled (25), “Primates” 126 which is labelled (26), “Cetaceans” 127 which is labelled (27), “Gray Whale” 128 which is labelled (28), “Length E” 129 which is labelled (29), “Weight E” 130 which is labelled (30), and “Beluga” 131 which is labelled (31).

It is possible to enter book mode part way through, i.e. starting at a node other than the top level node. In this case, the sequence proceeds as before, but from a different starting point. After the end of the display sequence, when “Beluga” 131 is displayed, then either a screenshot indicating the end of the sequence may be displayed, and/or the forward navigation control may cease to have effect until the user moves back in the sequence or switches to another mode. Alternatively, the sequence may restart at the beginning, i.e. at “Ecology” 101.

FIGS. 6a to 6d show a plurality of individual screenshots, and the way in which these screenshots inter-relate to one another during navigation from the top level of the node structure of FIG. 5 to the bottom level of the node structure of FIG. 5, in “book” navigation mode. FIG. 6a shows the transitions from “Ecology” 101 to “Plant” 102 to “Birds” 103 to “Cranes and Relatives” 104 to “Limpkin” 105 to “Length A” 106 to “Weight A” 107 to “Red-Legged Seriema” 108. Arrow A1 then indicates that the sequence continues on the next page, in FIG. 6b.

FIG. 6b shows the transitions starting at arrow A1 to “Length B” 109, “Weight B” 110, “Owls” 111, “Waders, Gulls and Auks” 112, “Pied Avocet” 113, “Atlantic Puffin” 114, “Length C” 115, and “Weight C” 116. Arrow A2 then indicates that the sequence continues on the next page, in FIG. 6c.

FIG. 6c shows the transitions starting at arrow A2, to “Reptiles” 117, “Lizards” 118, “invertebrates” 119, “Molluscs” 120, “Arthropods” 121, “Stag Beetles” 122, “Length D” 123 and “Weight D” 124. Arrow A3 then indicates that the sequence continues on the next page, in FIG. 6d.

FIG. 6d shows the transitions starting at arrow A3, to “Mammal” 125, “Primates” 126, “Cetaceans” 127, “Gray whale” 128, “Length E” 129, “Weight E” 130, and at the end of the sequence, “Beluga” 131.

FIG. 7 shows the tree diagram of FIG. 2, with additional labels to indicate the order of information display in a “group cycle” navigation mode with alphabetical ordering. “Group cycle” means navigation involving cycling within a particular group of nodes in a particular level of the hierarchy, and in this embodiment, such a group of nodes is all of the nodes in a level of the hierarchy which have a common parent node. The numbers in brackets beside each node on the diagram indicate the order of display of that node in the sequence. In addition, nodes are grouped by dashed lines, each of which surrounds a particular group of nodes. In this example, each group consists of all the nodes in a particular level of the hierarchy. Thus, the first group covers only the root node. If the apparatus is in “group cycle” navigation mode, and the current node is the root node, then neither forward nor back navigation selections will have any effect, because there are no other nodes in the group to navigate to. To move to a different node, a user may choose to enter a different navigation mode.

The second group of nodes covers all subnodes of the root node, namely “Plant” 102, “Birds” 103, “Reptiles” 117, “Invertebrates” 119 and “Mammal” 125. Since alphabetical ordering is used, these are displayed in the order Birds, Invertebrates, Mammal, Plant, and Reptiles. The order is indicated by the numbers (1) to (5) beside each node in the figure. As the display order is cyclical within the group, when the fifth node “Reptiles” is displayed, a forward navigation selection will result in the first node “Birds” being displayed again.

The third group covers all subnodes of the “Birds” 103 node. These, in alphabetical order are “Cranes and Relatives” 104, “Owls” 111, and “Waders, Gulls and Auks” 112, and their order is indicated by numbers (1) to (3) respectively on the figure.

The fourth group covers subnodes of the “Reptiles” 117 node. There is only one such subnode, which is “Lizards” 118, thus again, the forward and back navigation selections will have no effect in this mode when this node is displayed.

The fifth group covers subnodes of the “Invertebrates” 119 node, which are “Molluscs” 120 and “Arthropods” 121. The sixth group covers “primates” 126 and “Cetaceans” 127, both subnodes of the “Mammal” 126 node. The seventh, eighth, ninth and tenth groups all cover groups of nodes in the fourth level of the hierarchy. These are “Limpkin” 105 and “Red legged seriema” 108 for the seventh group, “Pied avocet” 113 and “Atlantic puffin” 114 for the eighth group, “Stag Beetles” 122 for the ninth group, and “Gray whale” 128 and “Beluga” 131 for the tenth group. The eleventh, twelfth, thirteenth, fourteenth and fifteenth groups are all at the fifth level of the hierarchy, and each group consists of a length and a weight node. For each group, the forward and back user selections will result in a cycling though of the nodes within the group.

FIGS. 8a and 8b are examples of screenshots within particular groups of FIG. 7, and the way in which these screenshots inter-relate to one another as navigation proceeds. FIG. 8a relates to the second group of FIG. 7, and shows a cycling through from “Birds” 103 to “Invertebrates” 119 to “Mammal” 125 to “Plant” 102 to “Reptiles” 117, then back to “Birds” 103. FIG. 8b relates to the third group of FIG. 7, and shows a cycling through from “Cranes and Relatives” 104 to “Owls” 111 to “Waders, Gulls and Auks” 112, then back to “Cranes and Relatives” 104.

FIG. 9 shows the tree diagram of FIG. 2, with additional labels to indicate the order of information display in a “group cycle” navigation mode with ordering based firstly on size, then alphabetical ordering. In this example, “size” means the number of nested subnodes. Numbers in brackets beside each node indicate the order or display of that node in the sequence.

As in FIG. 7, nodes are grouped by dashed lines, each of which surrounds a particular group of nodes. The node groupings are identical to those of FIG. 7, and only the order of nodes within each group is different.

FIG. 10 shows a plurality of individual screenshots, within the second group of FIG. 9, and the way in which these screenshots inter-relate to one another as navigation proceeds. FIG. 10 shows a cycling through from “Birds” 103 to “Mammal” 125 to “Invertebrates” 119 to “Reptiles” 117 to “Plant” 102, then back to “Birds” 103.

FIG. 11 shows the tree diagram of FIG. 2, with additional labels to indicate the order of information display in a “level cycle” navigation mode, using alphabetical ordering. Numbers in brackets beside each node indicate the order of display of that node in the sequence. In addition, nodes are grouped by dashed lines, each of which surrounds a particular group of nodes. In this example, each group consists of all the nodes in a particular level of the hierarchy. Thus, the first group covers only the root node, the second group covers all subnodes of the root node, the third group covers all nodes in the next level of the hierarchy, even though these nodes do not share a common parent node, etc.

On the top level, the first and only node, labelled as (1), is the root node “Ecology” 101.

On the second level, the first node is “Birds” 103 and is labelled (1). The second node is Invertebrates” 119, and is labelled (2). The third node is “Mammal” 125″ and is labelled (3). The fourth node is “Plant” 102 and is labelled (4). The fifth node is “Reptiles” 117 and is labelled (5). These five nodes are all grouped together by a dashed line in the figure which surrounds them as a group.

On the third level, the first node is “Arthropods” 121 and is labelled (1). The second node is “Cetaceans” 127, and is labelled (2). The third node is “Cranes and Relatives” 104 and is labelled (3). The fourth node is “Lizards” 118 and is labelled (4). The fifth node is “Molluscs” 120 and is labelled (5). The sixth node is “Owls” 111 and is labelled (6). The seventh node is “Primates” 126 and is labelled (7). The eighth node is “Waders, Gulls and Auks” 112 and is labelled (8). These eight nodes are all grouped together by a dashed line in the figure which surrounds them as a group.

On the fourth level, the first node is “Atlantic Puffin” 114 and is labelled (1). The second node is “Beluga” 131, and is labelled (2). The third node is “Gray Whale” 128 and is labelled (3). The fourth node is “Limpkin” 105 and is labelled (4). The fifth node is “Pied avocet” 113 and is labelled (5). The sixth node is “Red-legged seriema” 108 and is labelled (6). The seventh node is “Stag Beetles” 122 and is labelled (7). These seven nodes are all grouped together by a dashed line in the figure which surrounds them as a group.

On the fifth level, the first node is “Length A” 106 and is labelled (1). The second node is “Length B” 109, and is labelled (2). The third node is “Length C” 115 and is labelled (3). The fourth node is “Length D” 123 and is labelled (4). The fifth node is “Length E” 129 and is labelled (5). The sixth node is “Weight A” 107 and is labelled (6). The seventh node is “Weight B” 10 and is labelled (7). The eighth node is “Weight C” 116 and is labelled (8). The ninth node is “Weight D” 124 and is labelled (9). The tenth node is “Weight E” 130 and is labelled (10). These ten nodes are all grouped together by a dashed line in the figure which surrounds them as a group.

FIG. 12 shows a plurality of individual screenshots within the third level of FIG. 11, and the way in which these screenshots inter-relate to one another as navigation proceeds within the navigation mode illustrated in FIG. 11. FIG. 12 shows a cycling through from “Arthropods” 121 to “Cetaceans” 127 to “Cranes and Relatives” 104 to “Lizards” 118 to “Molluscs” 120 to “Owls” 111 to “Primates” 126 to “Waders, Gulls and Auks” 112, then back to “Arthropods” 121.

FIG. 13 shows the tree diagram of FIG. 2, with additional labels to indicate the order of information display in a “level cycle” navigation mode, using ordering based on size, then alphabetical ordering. Numbers in brackets beside each node indicate the order of display of that node in the sequence. in addition, nodes are grouped by dashed lines, each of which surrounds a particular group of nodes. In this example, each group consists of all the nodes in a particular level of the hierarchy. Thus, the first group covers only the root node, the second group covers all subnodes of the root node, the third group covers all nodes in the next level of the hierarchy, even though these nodes do not share a common parent node, etc.

On the top level, the first and only node, labelled as (1), is the root node “Ecology” 101.

On the second level, the first node is “Birds” 103 and is labelled (1). The second node is “Mammal” 125, and is labelled (2). The third node is “Invertebrates” 119 and is labelled (3). The fourth node is “Reptiles” 117 and is labelled (4). The fifth node is “Plant” 102 and is labelled (5). These five nodes are all grouped together by a dashed line in the figure which surrounds them as a group.

On the third level, the first node is “Cranes and Relatives” 104 and is labelled (1). The second node is “Cetaceans” 127, and is labelled (2). The third node is “Waders, Gulls and Auks” 112 and is labelled (3). The fourth node is “Arthropods” 121 and is labelled (4). The fifth node is “Molluses” 120 and is labelled (5). The sixth node is “Owls” 111 and is labelled (6). The seventh node is “Lizards” 118 and is labelled (7). The eighth node is “Primates” 126 and is labelled (8). These eight nodes are all grouped together by a dashed line in the figure which surrounds them as a group.

On the fourth level, the first node is “Atlantic Puffin” 114 and is labelled (1). The second node is “Gray Whale” 128, and is labelled (2). The third node is “Limpkin” 105 and is labelled (3). The fourth node is “Red-legged seriema” 108 and is labelled (4). The fifth node is “Stag Beetles” 122 and is labelled (5). The sixth node is “Beluga” 131 and is labelled (6). The seventh node is “Pied avocet” 113 and is labelled (7). These seven nodes are all grouped together by a dashed line in the figure which surrounds them as a group.

On the fifth level, the first node is “Length A” 106 and is labelled (1). The second node is “Length B” 109, and is labelled (2). The third node is “Length C” 115 and is labelled (3). The fourth node is “Length D” 123 and is labelled (4). The fifth node is “Length E” 129 and is labelled (5). The sixth node is “Weight A” 107 and is labelled (6). The seventh node is “Weight B” 110 and is labelled (7). The eighth node is “Weight C” 116 and is labelled (8). The ninth node is “Weight D” 124 and is labelled (9). The tenth node is “Weight E” 130 and is labelled (10). These ten nodes are all grouped together by a dashed line in the figure which surrounds them as a group.

FIG. 14 shows a plurality of individual screenshots within the third level of FIG. 13, and the way in which these screenshots inter-relate to one another as navigation proceeds within the “level cycle” navigation mode illustrated in FIG. 13. FIG. 14 shows a cycling through from “Cranes and Relatives” 104 to “Cetaceans” 127 to “Waders, Gulls and Auks” 112 to “Arthropods” 121 to “Molluscs” 120 to “Owls” 111 to “Lizards” 118 to “Primates” 126, then back to “Cranes and Relatives” 104.

FIG. 15 shows the tree diagram of FIG. 2, with additional labels to indicate the order of information display in a “zigzag” navigation mode, using alphabetical ordering. “Zigzag” mode is the same as “level cycle” mode, except that instead of cycling back to the first node of the level, in zigzag mode, the progression is to the first node of the next lowest level.

Thus, the sequence of node display is “zigzag” mode with alphabetical ordering is “Ecology” 101, “Birds” 103, Invertebrates” 119, “Mammal” 125, “Plant” 102, “Reptiles” 117, “Arthropods” 121, “Cetaceans” 127, “Cranes and Relatives” 104, “Lizards” 118, “Molluscs” 120, “Owls” 111, “Primates” 126, “Waders, Gulls and Auks” 112, “Atlantic Puffin” 114, “Beluga” 131, “Gray Whale” 128, “Limpkin” 105, “Pied avocet” 113, “Red-legged seriema” 108, “Stag Beetles” 122, “Length A” 106, “Length B” 109, “Length C” 115, “Length D” 123, “Length E”, “Weight A” 107, “Weight B” 110, “Weight C” 116, “Weight D” 124, and “Weight E” 130.

FIGS. 16a and 16b show a plurality of individual screenshots corresponding to part of the hierarchy of FIG. 15, and the way in which these screenshots inter-relate to one another as navigation proceeds within the “zigzag” navigation mode with alphabetical ordering.

FIG. 16a shows the transitions starting at “Ecology” 101, then proceeding to “Birds” 103, “Invertebrates” 119, “Mammal” 125, “Plant” 102, “Reptiles” 117, “Arthropods” 121, and “Cetaceans” 127. Arrow D2 then indicates that the sequence continues on the next page, in FIG. 6d.

FIG. 16b shows the transitions starting at arrow D2, to “Cranes and Relatives” 104, “Lizards” 118, “Molluscs” 120, “Owls” 111, “Primates” 126, “Waders, Gulls and Auks” 112, “Atlantic Puffin” 114, and “Beluga” 131. Arrow D3 then indicates that the sequence continues. In this example, the continuation is not shown.

FIG. 17 shows the tree diagram of FIG. 2, with additional labels to indicate the order of information display in a “zigzag” navigation mode, using ordering based on size, then alphabetical ordering. The principle is similar to that for FIG. 15, except that within each level, the nodes are order firstly according to their number of nested subnodes, and secondly, in alphabetical order.

Thus, the sequence of node display in “zigzag” mode with alphabetical ordering is “Ecology” 101, “Birds” 103, “Mammal” 125, Invertebrates” 119, “Reptiles” 117, “Plant” 102, “Cranes and Relatives” 104, “Cetaceans” 127, “Waders, Gulls and Auks” 112, “Arthropods” 121, “Molluscs” 120, “Owls” 111, “Lizards” 118, “Primates” 126, “Atlantic Puffin” 114, “Gray Whale” 128, “Limpkin” 105, “Red-legged seriema” 108, “Stag Beetles” 122, “Beluga” 131, “Pied avocet” 113, “Length A” 106, “Length B” 109, “Length C” 115, “Length D” 123, “Length E”, “Weight A” 107, “Weight B” 110, “Weight C” 116, “Weight D” 124, and “Weight E” 130.

FIGS. 18a and 18b show a plurality of individual screenshots corresponding to part of the hierarchy of FIG. 17, and the way in which these screenshots inter-relate to one another as navigation proceeds within the “zigzag” navigation mode with size then alphabetical ordering.

FIG. 18a shows the transitions starting at “Ecology” 101, then proceeding to “Birds” 103, “Mammal” 125, Invertebrates” 119, “Reptiles” 117, “Plant” 102, “Cranes and Relatives” 104, and “Cetaceans” 127. Arrow E2 then indicates that the sequence continues on the next page, in FIG. 6d.

FIG. 18b shows the transitions starting at arrow E2, to “Waders, Gulls and Auks” 112, “Arthropods” 121, “Molluscs” 120, “Owls” 111, “Lizards” 118, “Primates” 126, “Atlantic Puffin” 114, and “Gray Whale” 128. Arrow E3 then indicates that the sequence continues. In this example, the continuation is not shown.

FIG. 19a shows a screen layout 201 used to display menus in a further embodiment of the invention. A first menu is displayed on the left hand side of the screen, and a sub menu is displayed to the right of the first menu. The menus may be used during normal navigation to give a visual indication of the current location of the hierarchy, and the contents of the current node and parent node or sub node. Alternatively, the menus may be configured to operate using a further user input device, or a further part of a user input device (e.g. further keys on a keyboard), to provide a separate means of obtaining such visual information. In FIG. 19a, a remote control unit 205 is used for navigation and to select items from the menus. The remote control unit 205 has a back button 206, a forward button 207, a mode button 208, and further buttons which are not essential to embodiments of the invention, but which may be programmed with additional functions.

FIG. 19b shows an alternative screen layout 302 used to display menus. A first menu is displayed along the top of the screen, and a sub menu is displayed below it. Navigation controls, including a back button 306, a forward button 307 and a mode switch button 308, are displayed in the bottom part of the screen. Typically, but not exclusively, this type of layout may be used with a touch-screen apparatus.

FIG. 20 shows a screen layout 409 allowing navigation by both the user navigation buttons according to an embodiment of the invention, and an alternative pointer-type user input. The display represents a plurality of subnodes as folders within a node. Typically, such an embodiment will include further user input means, for example, a pointer device such as a mouse. The user may navigate using the mouse, or may alternatively navigate using the back 406, forward 407 and mode switch 408 buttons.

FIG. 21 shows an alternative screen layout 510 allowing navigation by both the user navigation buttons according to an embodiment of the invention, and an alternative pointer-type user input. Here, the back button 506, the forward button 507 and the mode switch button 508 are displayed at the bottom part of the screen 510.

The information of the information source may be stored and accessed in one of a plurality of different ways, to define the information hierarchy.

FIG. 22a is a computer screenshot showing an example of how the information store may be stored in the form of directories and subdirectories in a computer file system, with a structure corresponding to the structure of the information hierarchy. This example shows the contents of a directory labelled “Cetacea”. This is not the “Cetacea” directory of FIG. 2, but a separate example. The “Cetacea” directory has nine sub-directories, labelled “blue_whale”, “bowhead_whale”, “fin_whale”, “humpback_whale”, “northern_right whale”, “brydes_whale”, “gray_whale”, “minke_whale” and “sei_whale”. The “Cetacea” directory also contains a file, with filename “image.swf”, which is a Flash movie file. During navigation of the directory structure, in an embodiment of the invention, the “image.swf” file may be automatically played when navigation to the “Cetacea” directory is selected by a user.

FIG. 22b is a computer screenshot showing the contents of the “blue_whale” subdirectory. This subdirectory contains three further subdirectories, labelled “behaviour”, “classification” and “description”. It also contains a Flash movie file, with filename “image.swf”. During navigation of the directory structure, this “image.swf” file may be automatically played when navigation to the “blue_whale” subdirectory is selected by a user. Likewise, other subdirectories may also contain a file, e.g. a Flash movie file or some other type of file, that can be automatically activated or displayed when a user selects navigation to that particular subdirectory.

One alternative way of organising the storage of information from the information source is to use filenames specifying the location of a particular file in the information hierarchy. In that case, files corresponding to more than one level of the information hierarchy, or even all of the files making up the information source, may be stored in a single directory, in one embodiment of the invention.

FIG. 23 shows the contents of a single directory, relating to an information source in an embodiment of the invention. The directory contains no subdirectories, but contains files corresponding to a plurality of levels of the information hierarchy. The filename of each file specifies where in the information hierarchy the file belongs. For example, the file labelled “ecology-image.swf” is a Flash movie file at the top level of the information hierarchy. It may be played automatically in some embodiments of the invention, when the user begins navigation at the top of the hierarchy, or navigates to the top of the hierarchy.

The Flash movie files “ecology-amphibians-image.swf”, “ecology-amphibians-image.swf”, “ecology-birds-image.swf”, “ecology-fishes-image.swf”, “ecology-insect-image.swf”, “ecology-mammal-image.swf” and “ecology-plant-image.swf” each corresponding to a level of the information hierarchy that is immediately below the top level. For example, when a user chooses to navigate to the “Mammal” part of the information hierarchy, the “ecology-mammal-image.swf” file may automatically be played. The apparatus may also detect which files relate to the level immediately below “Mammal” in the hierarchy, by analysis of the filenames, and display these options to the user for further navigation. For example, “ecology-mammal-carnivore-image.swf” is directly below “Mammal” in the information hierarchy, but “ecology-mammal-cetacea-blue_whale-image.swf” is two levels below, and thus would not be displayed as an immediate navigation option in preferred embodiments of the invention.

As can be seen from the above example, a separator such as “-” may be used in the filename to indicate the separation between different parts of the filename corresponding to different levels of the information hierarchy. Alternative separators may be used instead, such as any selected character or character group that is not required for normal use within each part of the filename. Alternatively, a fixed length may be allocated to each part of the filename, to eliminate the need for a separator.

FIG. 24 shows examples of how a filename can be broken down into parts, and used to define the location of the file within an information hierarchy. The first example relates to the filename “ecology-mammal-cetacea-blue_whale-behaviour-image.swf”. The figure indicates how the dashes act as separators, and how the first part “ecology” relates to the title, the second part “mammal” relates to the class, the third part “cetacea” relates to the family, the fourth part “blue_whale” relates to the species name, the fifth part “behaviour” relates to the description, and the sixth part “image.swf” relates to the file format.

The second example of FIG. 24 shows how this type of organisation of a hierarchical information source may be used to allow storage of a user's custom files, or storage of files relating to a particular date and time. Again, a dash is used as a separator, to indicate different levels of the hierarchy. In this example, the filename is “david-2005-07-25-18-24-54-blue whale photo.jpg”, where “david” relates to the user ID, “2005” relates to the year, “07” relates to the month, “25” relates to the date (i.e. day of the month), “18” relates to the hour, “24” relates to the minute, “54” relates to the second, “blue whale photo” relates to the filename, and “.jpg” relates to the file format.

This second example illustrates how in some cases, it may be much more convenient to define a hierarchy using filenames or using a label or some sort of list, etc, rather than using an actual directory structure. If a separate directory was used for each individual minute and second, then most directories would contain only a single file. Thus, in certain embodiments, it may be more efficient in terms of file storage to use a labelling system, such as labelling position in the hierarchy with filename, rather than a multi-level directory system to define the structure of the information hierarchy.

FIG. 25 is a schematic diagram indicating the data flow between a navigation interface, an XML processor and data from an information source, in an embodiment of the invention. Information relating to user selection from the information source is passed from the navigation interface to the XML processor. The XML processor then retrieves the appropriate information from the data store. The XML processor processes the information as and if required, e.g. by converting filenames corresponding to subnodes in the information hierarchy into text for displaying to the user. The XML processor then sends the information on to the navigation interface.

The embodiment of FIG. 25 may be used with information that is stored or accessed in any of a plurality of different ways, such as the folder system of FIG. 22A-B, the single directory system of FIG. 23, any system that stores information on the position in the hierarchy within each file or in a separate indexing system, or a system in which at least some of the information is dynamically generated as required and may be accessed in a manner analogous to any of the above file storage systems.

Embodiments similar to that of FIG. 25 may be implemented using an alternative computer language or computer code, instead of or as well as XML. For example, PHP or SQL may be used.

The present invention can be implemented in dedicated hardware, using a programmable digital controller suitably programmed, or using a combination of hardware and software. Thus the present invention can be embodied by any suitable carrier medium for carrying machine readable instructions for controlling a programmable controller. The carrier medium can comprise any storage medium such as a floppy disk, CD ROM, magnetic tape, or programmable memory device, or a transient medium such as an electrical, optical or acoustical signal. An example of such a signal is an encoded signal carrying a computer code over a communications network, e.g. a TCP/IP signal carrying computer code over an IP network such as the Internet, an intranet, or a local area network.

Although specific embodiments of the invention have been described, further modifications are also possible. The code for each process in the methods according to the invention may be modular, or may be arranged in an alternative way to perform the same function. The methods and apparatus according to the invention are applicable to any computer with display means, including a handheld device.

While the invention has been described in terms of what are at present its preferred embodiments, it will be apparent to those skilled in the art that various changes can be made to the preferred embodiments without departing from the scope of the invention, which is defined by the claims.

1. Apparatus for displaying information from at least one information source, the information being indexed or arranged by an indexing scheme or arrangement that defines an information hierarchy, wherein the information hierarchy can be represented by a plurality of hierarchically arranged nodes, a plurality of said nodes each being associated with independently displayable information from the information source, the apparatus comprising:
at least one display for displaying information from the information source;
a user input device for receiving a user-selectable forward navigation selection, a user-selectable back navigation selection and a user-selectable mode switch selection; and
a controller for implementing a plurality of alternative navigation strategies to allow a user to navigate through at least part of the information hierarchy using said forward navigation selection and said back navigation selection in order to display user-selected information from the information source on said at least one display, the controller being configured to switch from a currently selected navigation strategy to another of said alternative navigation strategies in response to reception of said user-selectable mode switch selection, wherein each navigation strategy comprises one or more rules defining an order in which the information hierarchy is navigated, wherein said controller is configured to be switchable to a first navigation strategy to begin navigation of the hierarchical structure at a starting node corresponding to information displayed at a start time, wherein a current node is a node corresponding to currently displayed information, and an undisplayed subnode is a subnode corresponding to information which is not yet displayed since the start time, the first navigation strategy comprising at least the following rules for navigation within at least the part of the hierarchical structure descending from the starting node:
selecting an undisplayed subnode of the current node in response to a forward navigation selection, if such an undisplayed subnode exists in the hierarchical structure, and displaying information corresponding to the subnode;
if no undisplayed subnode of the current node exists, then selecting an undisplayed subnode of a parent node of the current node in response to a forward navigation selection, if such an undisplayed subnode of the parent node exists in the hierarchical structure, and displaying information corresponding to the subnode of the parent node; if no undisplayed subnode of the current node or said parent node exists, then selecting an undisplayed subnode of an ancestor node of the current node in response to a forward navigation selection, if such a subnode exists in the hierarchical structure, and displaying information corresponding to the subnode of the ancestor node, wherein said ancestor node is selected as a lowest of said ancestor nodes having an undisplayed subnode.

2. Apparatus as claimed in claim 1, wherein said first navigation strategy further includes an ordering rule for determining a relative order for displaying information corresponding to each subnode of a parent node.

3. Apparatus as claimed in claim 2, wherein the first navigation strategy further comprises the rule of: if none of the rules of claim 1 can be applied, and if at least one ancestor node of said current node has one or more undisplayed subnodes which are later in said relative order than any subnode of the ancestor node corresponding to information which has been displayed since the start time, then displaying information corresponding to the undisplayed subnode that is earliest in the relative order, for a lowest of said at least one ancestor nodes in the hierarchy, in response to a forward navigation selection.

4. Apparatus as claimed in claim 1, wherein said controller is configured to be switchable to a second navigation strategy to begin navigation of the hierarchical structure at a starting node corresponding to information displayed at a start time, wherein a current node is a node corresponding to currently displayed information and an undisplayed subnode is a subnode corresponding to information which is not yet displayed since the start time, the second navigation strategy comprising at least the following rules for navigation within at least the part of the hierarchical structure descending from the starting node:
navigating to an undisplayed subnode of a parent node of a current node in response to a forward navigation selection, if such an undisplayed subnode exists, and displaying information corresponding to said undisplayed subnode.

5. Apparatus as claimed in claim 4, wherein said rules for the second navigation strategy comprise cycling through all of the subnodes of said parent node of said starting node, to display information corresponding to each said subnode.

6. Apparatus as claimed in claim 4, wherein said rules for the second navigation strategy comprise cycling through all of the nodes in a level of the hierarchy, to display information corresponding to each said node.

7. Apparatus as claimed in claim 4, wherein said second navigation strategy further comprises the further rule of:
whenever a parent node of the current node does not contain an undisplayed subnode, navigating to a first node in a next lowest level lower in the hierarchy in response to a forward navigation selection, to display the corresponding information.

8. Apparatus as claimed in claim 4, wherein said second navigation strategy further includes an ordering rule for determining the relative order of display of information corresponding to subnodes of a parent node.

9. Apparatus for displaying information from at least one information source, the information being indexed or arranged by an indexing scheme or arrangement that defines an information hierarchy, wherein the information hierarchy can be represented by a plurality of hierarchically arranged nodes, a plurality of said nodes each being associated with independently displayable information from the information source, the apparatus comprising:
at least one display for displaying information from the information source;
a user input device for receiving a user-selectable forward navigation selection, a user-selectable back navigation selection and a user-selectable mode switch selection; and
a controller for implementing a plurality of alternative navigation strategies to allow a user to navigate through at least part of the information hierarchy using said forward navigation selection and said back navigation selection in order to display user-selected information from the information source on said at least one display, the controller being configured to switch from a currently selected navigation strategy to another of said alternative navigation strategies in response to reception of said user-selectable mode switch selection, wherein each navigation strategy comprises one or more rules defining an order in which the information hierarchy is navigated, wherein said controller is configured to be switchable to one navigation strategy to begin navigation of the hierarchical structure at a starting node corresponding to information displayed at a start time, wherein a current node is a node corresponding to currently displayed information and an undisplayed subnode is a subnode corresponding to information which is not yet displayed since the start time, said one navigation strategy comprising at least the following rules for navigation within at least the part of the hierarchical structure descending from the starting node: navigating to an undisplayed subnode of a parent node of a current node in response to a forward navigation selection, if such an undisplayed subnode exists, and displaying information corresponding to said undisplayed subnode.

10. Apparatus as claimed in claim 9, wherein said rules for said one navigation strategy comprise cycling through all of the subnodes of said parent node of said starting node, to display information corresponding to each said subnode.

11. Apparatus as claimed in claim 9, wherein said rules for said one navigation strategy comprise cycling through all of the nodes in a level of the hierarchy, to display information corresponding to each said node.

12. Apparatus as claimed in claim 9, wherein said controller is configured to switch to said one navigation strategy comprising the further rule of:
whenever a parent node of the current node does not contain an undisplayed subnode, navigating to a first node in a next lowest level lower in the hierarchy in response to a forward navigation selection, to display the corresponding information.

13. Apparatus as claimed in claim 9, wherein said one navigation strategy further includes an ordering rule for determining the relative order of display of information corresponding to subnodes of a parent node.

14. Apparatus as claimed in claim 9, wherein said controller is configured to be switchable to said further navigation strategy to begin navigation of the hierarchical structure at a starting node corresponding to information displayed at a start time, wherein a current node is a node corresponding to currently displayed information, and an undisplayed subnode is a subnode corresponding to information which is not yet displayed since the start time, said further navigation strategy comprising at least the following rules for navigation within at least the part of the hierarchical structure descending from the starting node: selecting an undisplayed subnode of the current node in response to a forward navigation selection, if such an undisplayed subnode exists in the hierarchical structure, and displaying information corresponding to the subnode; if no undisplayed subnode of the current node exists, then selecting an undisplayed subnode of a parent node of the current node in response to a forward navigation selection, if such an undisplayed subnode of the parent node exists in the hierarchical structure, and displaying information corresponding to the subnode of the parent node; if no undisplayed subnode of the current node or said parent node exists, then selecting an undisplayed subnode of an ancestor node of the current node in response to a forward navigation selection, if such a subnode exists in the hierarchical structure, and displaying information corresponding to the subnode of the ancestor node, wherein said ancestor node is selected as a lowest of said ancestor nodes having an undisplayed subnode.

15. Apparatus as claimed in claim 14, wherein said further navigation strategy further includes an ordering rule for determining a relative order for displaying information corresponding to each subnode of a parent node.

16. Apparatus as claimed in claim 15, wherein the further navigation strategy further comprises the rule of:
if none of the rules of claim 14 can be applied, and if at least one ancestor node of said current node has one or more undisplayed subnodes which are later in said relative order than any subnode of the ancestor node corresponding to information which has been displayed since the start time, then displaying information corresponding to the undisplayed subnode that is earliest in the relative order, for a lowest of said at least one ancestor nodes in the hierarchy, in response to a forward navigation selection.

17. Apparatus as claimed in claim 1, wherein the controller is adapted to automatically update the display to display information corresponding to a new node in response to user selection of a forward navigation selection or a back navigation selection.

18. Apparatus as claimed in claim 1, wherein said controller is adapted to accept a further user input specifying a search criteria, to do a search according to said search criteria, and to order said nodes using the results of said search.

19. Apparatus as claimed in claim 1, wherein said controller is adapted to accept a user input specifying a starting node to be used with a currently selected navigation strategy, and to display information corresponding to the starting node.

20. Apparatus as claimed in claim 19, further comprising additional user input means for providing said user input specifying a starting node.

21. Apparatus as claimed in claim 8, wherein said ordering rule comprises ordering the nodes according to a predetermined criteria.

22. Apparatus as claimed in claim 1, wherein the controller is configured to use a predetermined navigation mode prior to receiving a user-selectable mode switch selection.

23. Apparatus as claimed in claim 1, wherein each independently displayable information item in the information source is indexed by a label or filename or index that defines the position of the information item in the information hierarchy.

24. Apparatus as claimed in claim 23, further comprising means for navigating the hierarchy using said labels or filenames or index.

25. A method of displaying information from at least one information source, the information being indexed or arranged by an indexing scheme or arrangement that defines an information hierarchy, wherein the information hierarchy can be represented by a plurality of hierarchically arranged nodes, a plurality of said nodes each being associated with independently displayable information from the information source, the method comprising:
displaying information from the information source on at least one display; receiving a user-selectable forward navigation selection, a user-selectable back navigation selection and a user-selectable mode switch selection from a user input device; and implementing a plurality of alternative navigation strategies to allow a user to navigate through at least part of the information hierarchy using said forward navigation selection and said back navigation selection in order to display user-selected information from the information source on said at least one display, by switching from a currently selected navigation strategy to another of said alternative navigation strategies in response to reception of said user-selectable mode switch selection, wherein each navigation strategy comprises one or more rules defining an order in which the information hierarchy is navigated, wherein said controller is configured to be switchable to a first navigation strategy to begin navigation of the hierarchical structure at a starting node corresponding to information displayed at a start time, wherein a current node is a node corresponding to currently displayed information, and an undisplayed subnode is a subnode corresponding to information which is not yet displayed since the start time, the first navigation strategy comprising at least the following rules for navigation within at least the part of the hierarchical structure descending from the starting node: selecting an undisplayed subnode of the current node in response to a forward navigation selection, if such an undisplayed subnode exists in the hierarchical structure, and displaying information corresponding to the subnode; if no undisplayed subnode of the current node exists, then selecting an undisplayed subnode of a parent node of the current node in response to a forward navigation selection, if such an undisplayed subnode of the parent node exists in the hierarchical structure, and displaying information corresponding to the subnode of the parent node; if no undisplayed subnode of the current node or said parent node exists, then selecting an undisplayed subnode of an ancestor node of the current node in response to a forward navigation selection, if such a subnode exists in the hierarchical structure, and displaying information corresponding to the subnode of the ancestor node, wherein said ancestor node is selected as a lowest of said ancestor nodes having an undisplayed subnode.

26. A method as claimed in claim 25, wherein said first navigation strategy further includes an ordering rule for determining a relative order for displaying information corresponding to each subnode of a parent node.

27. A method as claimed in claim 26, wherein the first navigation strategy further comprises the rule of:
if none of the rules of claim 25 can be applied, and if at least one ancestor node of said current node has one or more undisplayed subnodes which are later in said relative order than any subnode of the ancestor node corresponding to information which has been displayed since the start time, then displaying information corresponding to the undisplayed subnode that is earliest in the relative order, for a lowest of said at least one ancestor nodes in the hierarchy, in response to a forward navigation selection.

28. A method as claimed in claim 25, wherein in a second navigation strategy, navigation of the hierarchical structure begins at a starting node corresponding to information displayed at a start time, wherein a current node is a node corresponding to currently displayed information and an undisplayed subnode is a subnode corresponding to information which is not yet displayed since the start time, the second navigation strategy comprising at least the following rules for navigation within at least the part of the hierarchical structure descending from the starting node: navigating to an undisplayed subnode of a parent node of a current node in response to a forward navigation selection, if such an undisplayed subnode exists, and displaying information corresponding to said undisplayed subnode.

29. A method as claimed in claim 28, wherein said rules for the second navigation strategy comprise cycling through all of the subnodes of said parent node of said starting node, to display information corresponding to each said subnode.

30. A method as claimed in claim 28, wherein said rules for the second navigation strategy comprise cycling through all of the nodes in a level of the hierarchy, to display information corresponding to each said node.

31. A method as claimed in claim 28, wherein said second navigation strategy comprises the further rule of: whenever a parent node of the current node does not contain an undisplayed subnode, navigating to a first node in a next lowest level lower in the hierarchy in response to a forward navigation selection, to display the corresponding information.

32. A method as claimed in claim 28, wherein said second navigation strategy further includes an ordering rule for determining the relative order of display of information corresponding to subnodes of a parent node.

33. A method for displaying information from at least one information source, the displayable information in the information source being indexed or arranged by an indexing scheme or arrangement that defines an information hierarchy, wherein the information hierarchy can be represented by a plurality of hierarchically arranged nodes, a plurality of said nodes each being associated with independently displayable information from the information source, the method comprising:
displaying information from the information source on at least one display;
receiving a user-selectable forward navigation selection, a user-selectable back navigation selection and a user-selectable mode switch selection on a user input device; and
implementing a plurality of alternative navigation strategies to allow a user to navigate through at least part of the information hierarchy using said forward navigation selection and said back navigation selection in order to display user-selected information from the information source on said at least one display, by switching from a currently selected navigation strategy to another of said alternative navigation strategies in response to reception of said user-selectable mode switch selection, wherein each navigation strategy comprises one or more rules defining an order in which the information hierarchy is navigated, wherein said controller is configured to be switchable to one navigation strategy to begin navigation of the hierarchical structure at a starting node corresponding to information displayed at a start time, wherein a current node is a node corresponding to currently displayed information and an undisplayed subnode is a subnode corresponding to information which is not yet displayed since the start time, said one navigation strategy comprising at least the following rules for navigation within at least the part of the hierarchical structure descending from the starting node:
navigating to an undisplayed subnode of a parent node of a current node in response to a forward navigation selection, if such an undisplayed subnode exists, and displaying information corresponding to said undisplayed subnode.

34. A method as claimed in claim 33, wherein said rules for said one navigation strategy comprise cycling through all of the subnodes of said parent node of said starting node, to display information corresponding to each said subnode.

35. A method as claimed in claim 33, wherein said rules for said one navigation strategy comprise cycling through all of the nodes in a level of the hierarchy, to display information corresponding to each said node.

36. A method as claimed in claim 33, wherein said one navigation strategy comprises the further rule of: whenever a parent node of the current node does not contain an undisplayed subnode, navigating to a first node in a next lowest level lower in the hierarchy in response to a forward navigation selection, to display the corresponding information.

37. A method as claimed in claim 33, wherein said one navigation strategy further includes an ordering rule for determining the relative order of display of information corresponding to subnodes of a parent node.

38. A method as claimed in claim 33, wherein in a further navigation strategy, navigation of the hierarchical structure begins at a starting node corresponding to information displayed at a start time, wherein a current node is a node corresponding to currently displayed information, and an undisplayed subnode is a subnode corresponding to information which is not yet displayed since the start time, said further navigation strategy comprising at least the following rules for navigation within at least the part of the hierarchical structure descending from the starting node:
selecting an undisplayed subnode of the current node in response to a forward navigation selection, if such an undisplayed subnode exists in the hierarchical structure, and displaying information corresponding to the subnode;
if no undisplayed subnode of the current node exists, then selecting an undisplayed subnode of a parent node of the current node in response to a forward navigation selection, if such an undisplayed subnode of the parent node exists in the hierarchical structure, and displaying information corresponding to the subnode of the parent node;
if no undisplayed subnode of the current node or said parent node exists, then selecting an undisplayed subnode of an ancestor node of the current node in response to a forward navigation selection, if such a subnode exists in the hierarchical structure, and displaying information corresponding to the subnode of the ancestor node, wherein said ancestor node is selected as a lowest of said ancestor nodes having an undisplayed subnode.

39. A method as claimed in claim 38, wherein said further navigation strategy further includes an ordering rule for determining a relative order for displaying information corresponding to each subnode of a parent node.

40. A method as claimed in claim 39, wherein the further navigation strategy further comprises the rule of:
if none of the rules of claim 38 can be applied, and if at least one ancestor node of said current node has one or more undisplayed subnodes which are later in said relative order than any subnode of the ancestor node corresponding to information which has been displayed since the start time, then displaying information corresponding to the undisplayed subnode that is earliest in the relative order, for a lowest of said at least one ancestor nodes in the hierarchy, in response to a forward navigation selection.

41. A method as claimed in claim 25, further comprising automatically updating the display to display information corresponding to a new node in response to user selection of a forward navigation selection or a back navigation selection.

42. A method as claimed in claim 25, further comprising accepting a further user input specifying a search criteria, to do a search according to said search criteria, and to order said nodes using the results of said search.

43. A method as claimed in claim 25, further comprising accepting a user input specifying a starting node to be used with a currently selected navigation strategy, and displaying information corresponding to the starting node.

44. A method as claimed in claim 43, further comprising using additional user input means for providing said user input specifying a starting node.

45. A method as claimed in claim 33, wherein said ordering rule comprises ordering the nodes according to a predetermined criteria.

46. A method as claimed in claim 25, further comprising using a predetermined navigation mode prior to receiving a user-selectable mode switch selection.

47. A method as claimed in claim 25, wherein each independently displayable information item in the information source is indexed by a label or filename or index that defines the position of the information item in the information hierarchy.

48. A method as claimed in claim 47, further comprising navigating the hierarchy using said labels or filenames or index.

49. A carrier medium carrying computer readable code for configuring a computer as the apparatus of claim 1.

50. A display controller for use with an input device and a display for displaying information from an information source, the information being indexed or arranged by an indexing scheme or arrangement that defines an information hierarchy, wherein the information hierarchy can be represented by a plurality of hierarchically arranged nodes, a plurality of said nodes each being associated with independently displayable information from the information source, the display controller comprising: means for implementing a plurality of alternative navigation strategies to allow a user to navigate through at least part of the information hierarchy using a user-selectable forward navigation selection and a user-selectable back navigation selection received from the user input device in order to display user-selected information from the information source on said at least one display, the controller being configured to switch from a currently selected navigation strategy to another of said alternative navigation strategies in response to reception of said user-selectable mode switch selection from the user input device, wherein each navigation strategy comprises one or more rules defining an order in which the information hierarchy is navigated.
